(19) United States
(12) Patent Application Publication
(10) Pub. No.: US 2023/0417673 A1
(43) Pub. Date: Dec. 28, 2023

(54) AUTONOMOUS MEASUREMENT SYSTEM FOR PERFORMING CHEMICAL CONCENTRATION MEASUREMENTS IN AN INDUSTRIAL PROCESS STREAM

(71) Applicant: Dean G Gouramanis, Lindenhurst, NY (US)

(72) Inventor: Dean G Gouramanis, Lindenhurst, NY (US)

(21) Appl. No.: 18/340,967

(22) Filed: Jun. 26, 2023

Related U.S. Application Data
(60) Provisional application No. 63/472,817, filed on Jun. 13, 2023.
(60) Provisional application No. 63/355,602, filed on Jun. 25, 2022.
(60) Provisional application No. 63/407,657, filed on Sep. 17, 2022.

(51) Int. Cl. G01N 21/64; G01N 1/20; G01N 35/10

(52) U.S. Cl. CPC G01N 21/6428; G01N 1/20; G01N 35/1002

(57) ABSTRACT

In an embodiment, a fluid concentration measurement system is disclosed that includes a sensor device including a sample cavity that is configured for insertion into an industrial process stream. The sample cavity is configured to obtain a fluid sample from the industrial process stream and to mix a reagent with the fluid sample in the sample cavity to form a mixed sample. The sensor device includes a light source that is configured to illuminate the mixed sample in the sample cavity and an optical sensor that is configured to receive light from the mixed sample and generate sensor data based on the received light. The sensor device includes at least one processor that is configured to obtain the sensor data, correct the sensor data for at least one attribute of the industrial process stream and determine a concentration of a target analyte based on the corrected sensor data.

### CROSS REFERENCE TO RELATED APPLICATION

This application claims the benefit of U.S. Provisional Patent application No. 63/355,602, filed on Jun. 25, 2022, and entitled “INTEGRATED SENSOR DEVICE FOR CONTINUOUS MONITORING OF PROCESS STREAM USING LUMINOUS FLUID SENSING ELEMENTS” the content of which is incorporated by reference herein in its entirety.

This application claims the benefit of U.S. Provisional Patent application No. 63/407,657, filed on Sep. 17, 2022, and entitled “INTEGRATED DEVICE FOR CONTINUOUS MONITORING OF PROCESS STREAM USING LUMINOUS FLUID SENSING ELEMENTS” the content of which is incorporated by reference herein in its entirety.

This application claims the benefit of U.S. Provisional Patent application No. 63/472,817, filed on Jun. 13, 2023, and entitled “CONFIGURABLE OPTICAL SENSOR FOR CONCENTRATION MEASUREMENT OF VARIOUS CHEMICAL COMPOUNDS IN FLUID” the content of which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This application relates to performing chemical concentration measurements in an industrial process stream, and in particular, to a system and process for autonomously performing chemical concentration measurements in an industrial process stream.

Industrial process streams, such as those comprising fluids flowing within pipes and tanks in an industrial processing center, may be pressurized, corrosive, hazardous, extremely hot, extremely cold, located in hard to reach areas or have other attributes that may make it difficult to obtain measurements directly from the stream. Typically, a sample of the fluid in the industrial process stream must be manually extracted from the industrial process stream and taken to another location for measurement testing, e.g., in a local laboratory on-site or in a remote laboratory. Such a manual process for measurement testing of an industrial process stream may be dangerous to the individual taking the sample, e.g., due to the potentially hazardous nature of the industrial process stream. In addition, such a manual process may lose accuracy relative to the chemical concentrations actually found in the industrial process stream due to the delay involved in taking the sample, the delay in relocating the sample to the laboratory, the delay in testing the sample at the laboratory, the opportunity for contamination of the sample and a change in environmental variables relative to those existing in-situ at the industrial process stream.

### SUMMARY

In an embodiment, a fluid concentration measurement system is disclosed, the fluid concentration measurement system comprises a sensor device comprising a sample cavity that is configured for insertion into an industrial process stream. The sample cavity is configured to obtain a fluid sample from the industrial process stream and to mix a reagent with the fluid sample in the sample cavity to form a mixed sample. The sensor device further comprises a light source that is configured to illuminate the mixed sample in the sample cavity and an optical sensor that is configured to receive light from the mixed sample and generate sensor data based on the received light. The sensor device further comprises at least one processor that is configured to obtain the sensor data, correct the sensor data for at least one attribute of the industrial process stream and determine a concentration of a target analyte based on the corrected sensor data.

In an embodiment, the sample cavity comprises a chamber. The chamber is exposed to the industrial process stream when the sensor device is in a first configuration and is closed off from the industrial process stream when the sensor device is in a second configuration.

In an embodiment, the chamber is exposed to the industrial process stream through at least one orifice when the sensor device is in a first configuration. The at least one orifice is closed when the sensor device is in a second configuration.

In an embodiment, the sample cavity comprises a well that is configured for positioning within the industrial process stream.

In an embodiment, the sensor device is configured to be removably coupled to a structure comprising the industrial process stream.

In an embodiment, the at least one processor is configured to obtain the sensor data, correct the sensor data for the at least one attribute of the industrial process stream and determine the concentration of the target analyte based on the corrected sensor data while the sample cavity is inserted into the industrial process stream.

In an embodiment, the at least one processor being configured to correct the sensor data for the at least one attribute of the industrial process stream comprises the at least one processor being configured to access a look-up-table corresponding to the at least one attribute of the industrial process stream and correcting the sensor data based at least in part on the look-up-table, a value corresponding to the at least one attribute and the sensor data.

In an embodiment, the at least one processor is configured to obtain an updated look-up-table corresponding to the at least one attribute and replace the look-up-table with the updated look-up-table.

In an embodiment, the sensor device comprises a reagent supply channel that is configured to supply the reagent to the sample cavity.

In an embodiment, the sample cavity comprises a membrane that is configured to dispense the reagent.

In an embodiment, the sensor device comprises a window disposed between the industrial process stream and the light source and optical sensor and configured to seal the light source and optical sensor from at least one attribute of the industrial process stream while permitting a transmission of light between the light source and industrial process stream and between the industrial process stream and the optical sensor.

In an embodiment, the sensor device comprises a filter selected based at least in part on the target analyte and being disposed between the sample cavity and the optical sensor to filter light received by the optical sensor from the sample cavity.

In an embodiment, the optical sensor comprises a plurality of optical sensors. Each optical sensor comprising a corresponding filter.

In an embodiment, the sensor device comprises a lens disposed between the optical sensor and the sample cavity. The lens is configured to collimate the light received by the optical sensor from the mixed sample.

In an embodiment, a method performed by at least one processor of a sensor device is disclosed. The method comprises causing a supply of a reagent to a sample cavity of the sensor device. The sample cavity is positioned within an industrial process stream and comprises a fluid sample of the industrial process stream. The reagent combines with the fluid sample to form a mixed sample. The method further comprises causing a light source of the sensor device to illuminate the mixed sample of the sample cavity, obtaining, from an optical sensor of the sensor device, sensor data obtained by the optical sensor based at least in part on light received from the mixed sample in conjunction with the illumination of the mixed sample by the light source, correcting the sensor data for at least one attribute of the industrial process stream and determining a concentration of a target analyte based on the corrected sensor data.

In an embodiment, the method comprises obtaining the sensor data, correcting the sensor data for the at least one attribute of the industrial process stream and determining the concentration of the target analyte based on the corrected sensor data while the sample cavity is positioned within the industrial process stream.

In an embodiment, the method comprises accessing a look-up-table corresponding to the at least one attribute of the industrial process stream and correcting the sensor data based at least in part on the look-up-table, a value corresponding to the at least one attribute and the sensor data.

In an embodiment, the method further comprises obtaining an updated look-up-table corresponding to the at least one attribute and replacing the look-up-table with the updated look-up-table.

In an embodiment, a method of fabricating a sensor device is disclosed. The method comprises forming a sensor device comprising a housing and a sample cavity disposed distally of the housing. The housing comprises a light source and an optical sensor. The optical sensor is optically exposed to the sample cavity. The method comprises determining a target analyte of an industrial process stream, selecting a filter based at least in part on the determined target analyte of the industrial process stream and attaching the filter to the housing between the optical sensor and the sample cavity.

In an embodiment, the housing comprises a through hole having a well. The through hole optically exposes the optical sensor to the sample cavity. Attaching the filter to the housing between the optical sensor and the sample cavity comprises positioning the filter within the well.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIGS. 1-3 are perspective views of a system and sensor device according to an embodiment.

FIG. 4 is a perspective view of the sensor device of FIGS. 1-3 showing a cover plate removed according to an embodiment.

FIG. 5 is a perspective view of the sensor device of FIGS. 1-3 showing a proximal cavity according to an embodiment.

FIGS. 6 and 7 are perspective views of circuitry of the sensor device of FIGS. 1-3 according to an embodiment.

FIGS. 8-10 are perspective views of the sensor device of FIGS. 1-3 installed in a coupling of a structure according to an embodiment.

FIGS. 11 and 12 are perspective views of the sensor device of FIGS. 1-3 showing light beams according to an embodiment.

FIG. 13 is a cross-sectional view of the sensor device of FIGS. 11 and 12 according to an embodiment.

FIGS. 14 and 15 are cross-sectional views of an armature and sample unit of the sensor device of FIGS. 1-3 according to an embodiment.

FIG. 16 is a perspective view of the sensor device of FIGS. 8-10 showing a flow path of an industrial process stream according to an embodiment.

FIGS. 17-18 are cross-sectional views of the sensor device of FIG. 16 showing a flow path of the industrial process stream and a reagent according to an embodiment.

FIG. 19 is a block diagram of components of the sensor device of FIGS. 1-3 according to an embodiment.

FIG. 20 is a block diagram of components of the sensor device of FIGS. 1-3 according to an embodiment.

FIGS. 21-29 are perspective and cross-sectional views of a system and sensor device according to another embodiment.

FIGS. 30-33 are example diagrams corresponding to a process of identifying analyte concentrations according to an embodiment.

FIG. 34 is a flow diagram of a process for computing a concentration of an analyte according to an embodiment.

FIG. 35 is a flow diagram of a process for exciting a reagent and analyte and obtaining optical data according to an embodiment.

FIG. 36 is a block diagram of example components of a sensor device according to an embodiment.

FIG. 37 is a block diagram of example components of a sensor device according to an embodiment.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized, and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

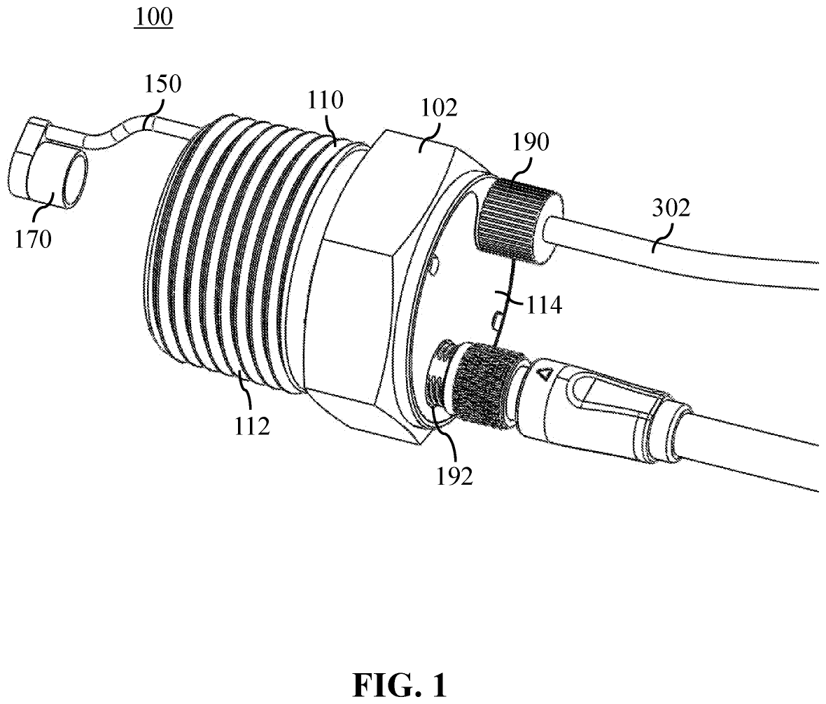

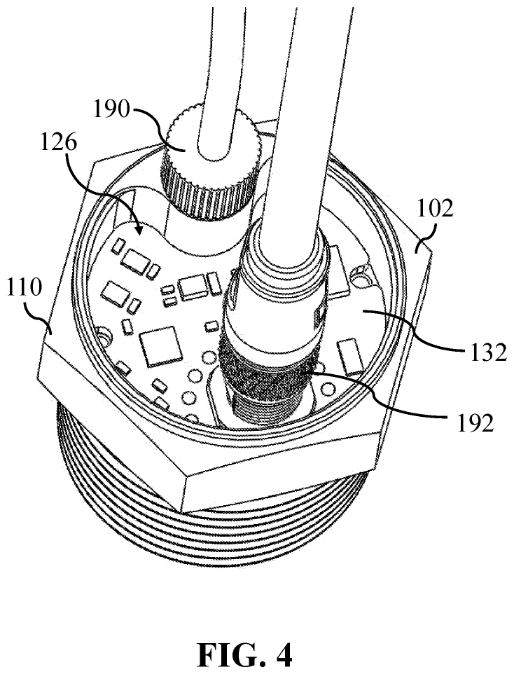

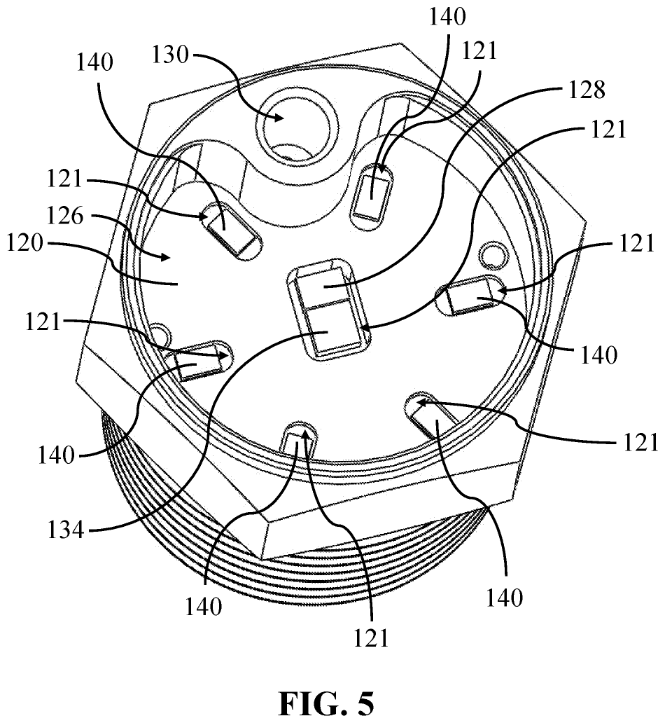

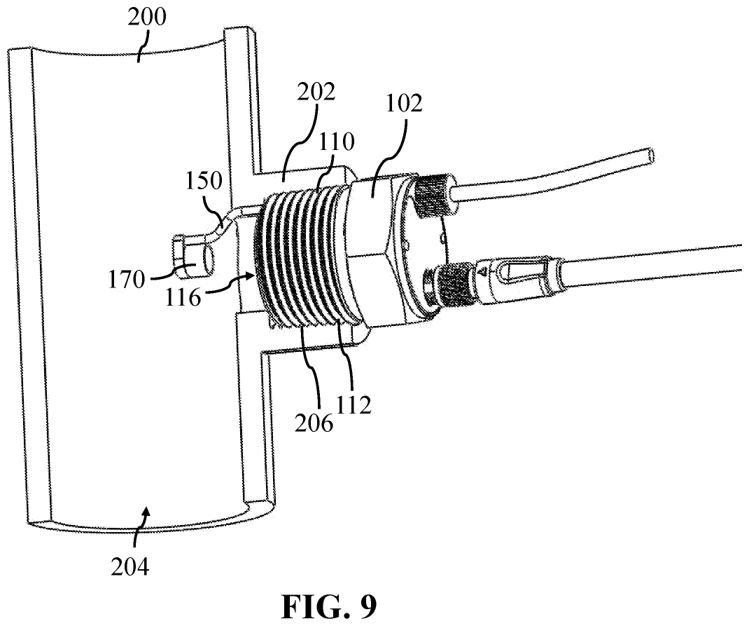

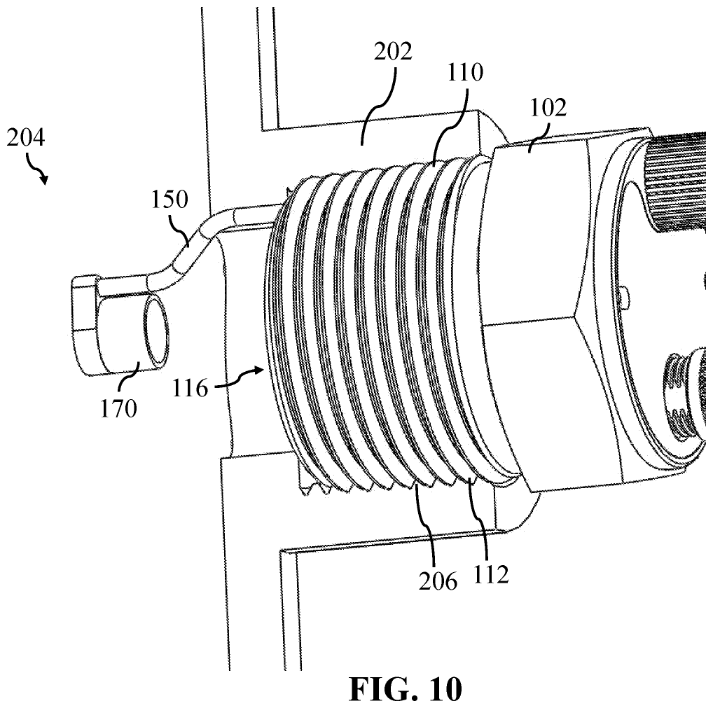

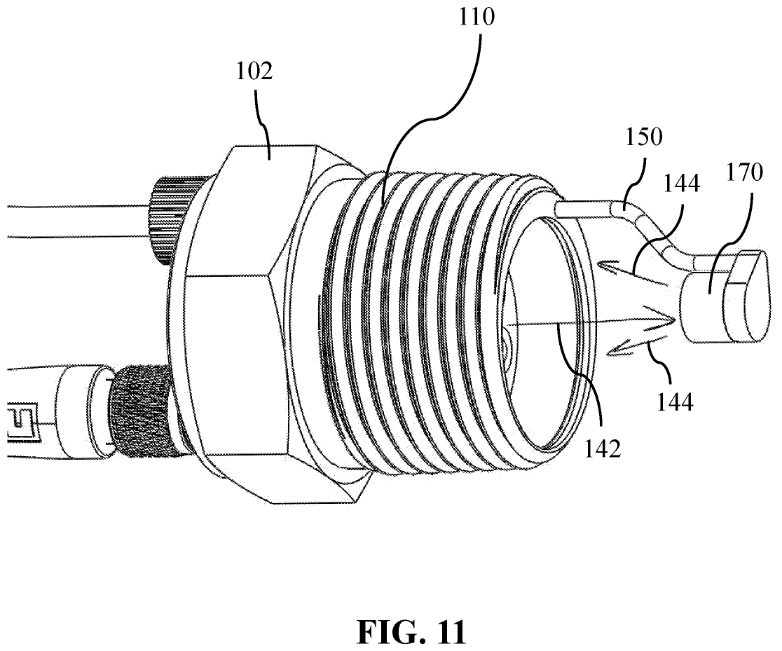

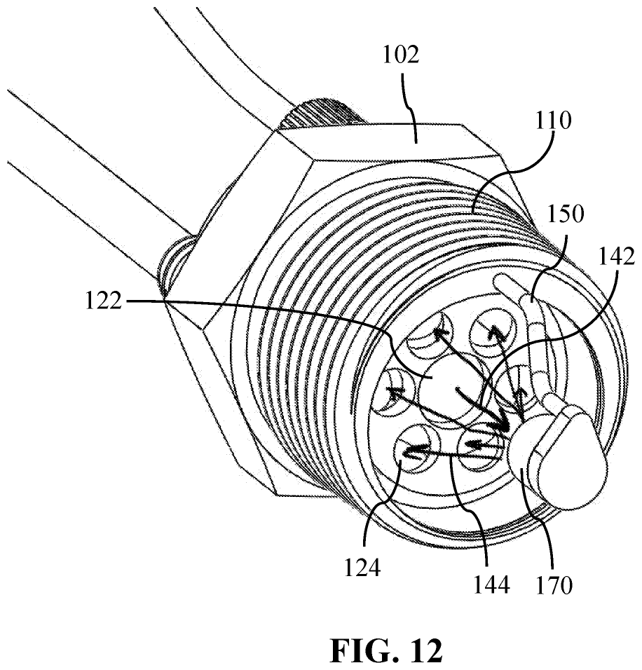

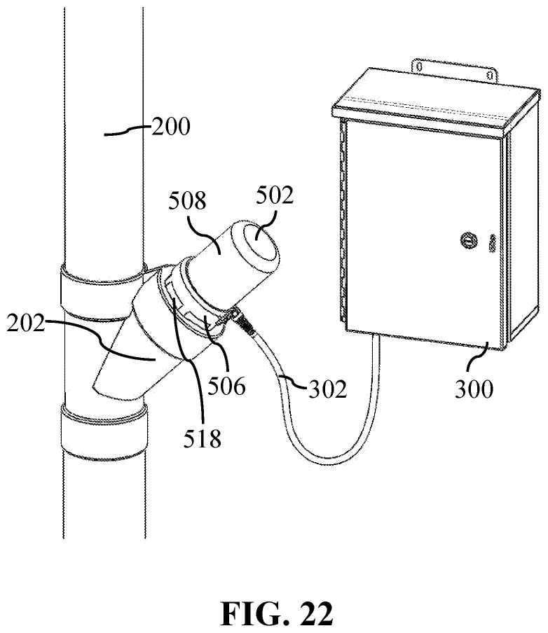

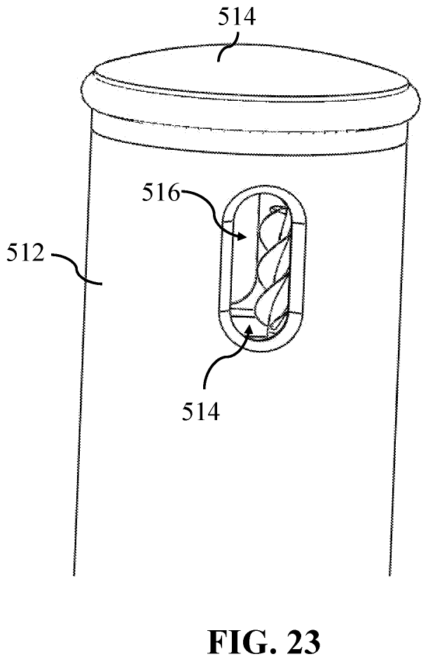

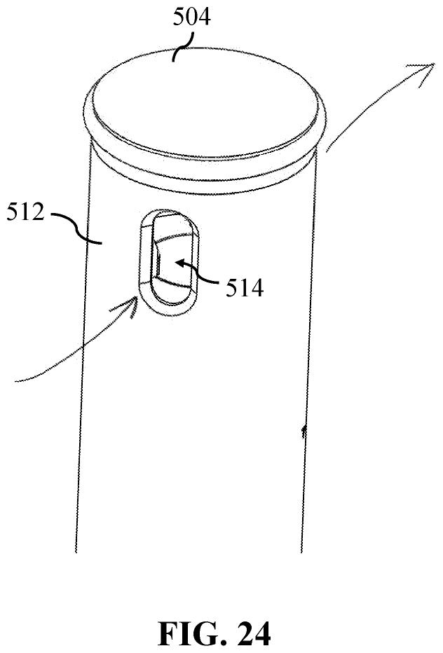

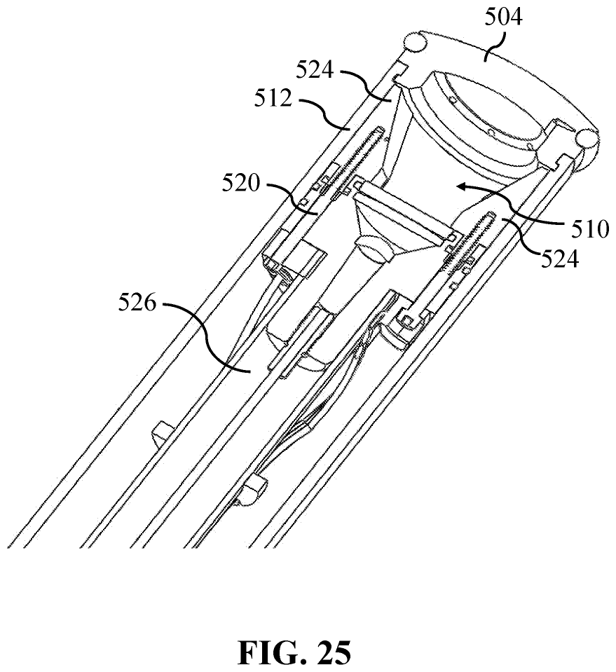

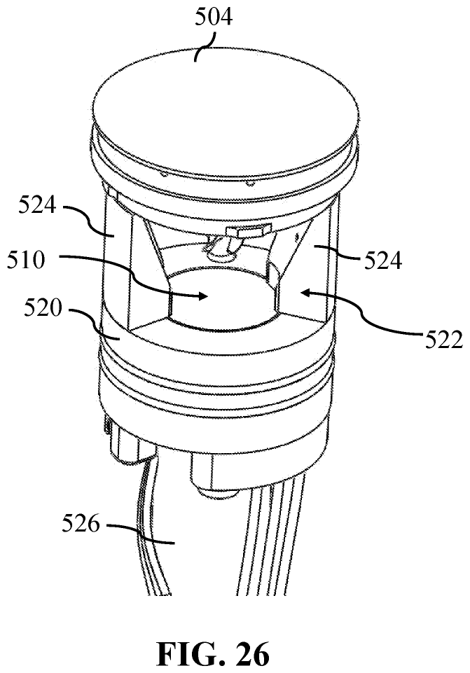

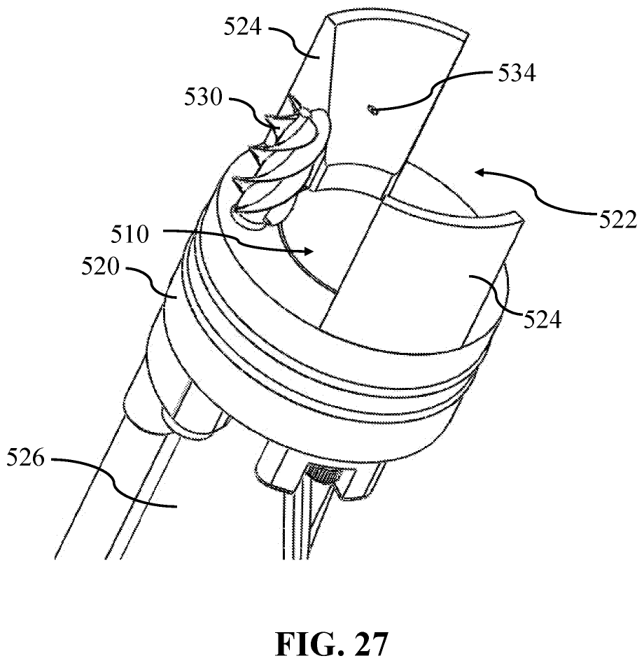

With reference to FIGS. 1-37, a system 100 is disclosed that implements a platform for autonomously performing chemical concentration measurements in-situ in an industrial process stream. System 100 is configured to utilize a reagent that interacts with a chemical of interest found in the industrial process stream in order to induce an optical signal, e.g., a fluorescence. System 100 comprises integrated instrumentation that is packaged within a sensor device 102 that is deployable at least partially within an industrial process stream and configured to autonomously perform measurements of chemical concentrations in-situ within the industrial process stream. While described herein with respect to industrial process streams, system 100 and sensor device 102 may be utilized for any other fluid flow system including, for example, rivers, sewage, water supply, or any other fluid flow system.

Sensor device 102 comprises functionality that facilitates automated collection of measurement data directly from the industrial process stream, enabling more accurate, targeted and timely measurement of chemical concentrations within the industrial process stream while also reducing the exposure of individuals such as workers at the chemical processing facility to the industrial process stream due to manual sampling. Sensor device 102 leverages laboratory-proven analytical techniques in a package that is deployable in a variety of locations within a chemical processing facility to perform autonomous chemical concentration measurements. Sensor device 102 may be configured to provide measurement data electronically, e.g., in a wired or wireless manner, to a computer network, server, or any other computing device.

Sensor device 102 is readily configurable to quantify various analytes by manipulating interchangeable fluid sensing elements, interchangeable optical filter elements and electronic programmable calibration files. Sensor device 102 may, for example, comprise all necessary sub-systems for the detection of specific materials and their concentrations within an industrial process stream.

For example, sensor device 102 may be utilized to quantify concentrations of rare earth element ions within an industrial process stream at a chemical refinement facility by using a reagent comprising a fluorescent sensitizer solution containing a Metal-Organic Framework (MOF). In some embodiments, such a sensor device 102 may also or alternatively be utilized to quantify concentrations of the rare earth element ions within any other fluid system including, e.g., a public waterway that is contaminated with acid-mine drainage.

In another example, sensor device 102 may be utilized to measure phosphate levels in a lake that is contaminated by fertilizer runoff, e.g., by using a reagent comprising a solution containing genetically-modified bacteria. Fluorescent proteins have become a valuable tool in modern biomedical research where genetically modified cells may act as living sensors, producing fluorescent proteins in the presence of specific analytes.

In some embodiments, sensor device 102 is configured to utilize a reagent comprising a consumable liquid sensing material that provides improved performance over sensors utilizing solid chemical cells. For example, solid and stationary fluorescent sensing materials may degrade rapidly in corrosive, hot or pressurized industrial process streams. In addition, the accuracy of a sensor may depend heavily on the freshness of the reagent, such as reagents containing living microbes, or a reagent containing proteins which denature at high temperatures. Sensor device 102 is configured to mix a controlled volume of the reagent, such as consumable liquid reagent, with the industrial process stream, and perform the measurement process before significant degradation of the reagent occurs.

System 100 is also configured to provide ease of use and utility to research and engineering individuals that are utilizing sensor device 102. For example, system 100 is configured to provide a user interface and integrated computation framework that may be utilized to update the calibration of sensor device 102. As an example, sensor device 102 may be calibrated using experimental characterization data such as that identified or generated in a laboratory setting, which may be uploaded to sensor device 102 via a wired or wireless connection. This functionality enables the research and engineering individuals or any other individual to rapidly functionalize analytical techniques for performing chemical concentration measurements that have been demonstrated in the laboratory within the industrial process stream or fluid system of a relevant operating environment via sensor device 102. Sensor device 102 provides a scalable solution for advanced process monitoring at many locations in a chemical processing facility or any other fluid system.

With reference to FIGS. 1-19, sensor device 102 comprises a housing 110, an armature 150 extending distally from housing 110, a sample unit 170 disposed at a distal end portion of armature 150, a fluid inlet connection 190 coupled to a proximal portion of sensor device 102 and a data input/outlet connection 192 coupled to a proximal portion of sensor device 102. As described herein, distal refers to a direction toward an industrial process stream while proximal corresponds to a direction away from the industrial process stream.

The environment occupied by sensor device 102 may contain corrosive or biological substances that act to degrade the components of sensor device 102 over time. Sensor device 102 may be designed to anticipate interface surfaces that may be subject to destructive substances. For example, in some embodiments, sensor device 102 may comprise internal stainless steel components but may utilize other materials for those components exposed to the industrial process stream or other local environment since metallic materials may degrade or corrupt measurements when exposed to the industrial process stream. For this reason, exterior surfaces of sensor device 102 or those components being exposed to the process stream or other hazardous or corrosive environments, comprise materials that may be resistant to these environments such as, e.g., Polytetrafluoroethylene or PVDF plastic materials, metal or glass-coated graphite, ceramics or other materials as needed to facilitate usage within those environments, extend the life of sensor device 102 within those environments or for any other purpose. In some embodiments, inner cavities or components of sensor device 102 may be filled with corrosion-inhibiting substances such as oil or epoxy where feasible in order to reduce the occurrence of degradation in the components.

With reference to FIGS. 1-10, housing 110 comprises a coupling component 112, cover plate 114, a distal cavity 116, a window 118, a separation plate 120, an illumination lens component 122, receptor lens components 124, a proximal cavity 126, reflective component 128, a reagent flow channel 130, circuitry 132, a light source 134, a brightness detector 136, optical sensors 138 and filters 140. In some embodiments, housing 110 comprises, for example, a pipe fitting or other similar component that is configured for easy and standardized installation on fluid control systems such as, e.g., pipes, tanks, ducts or other components of a fluid control system through which an industrial process stream flows. Housing 110 may be fabricated or injection molded from a sturdy and corrosion resistant material such as stainless steel, nylon, polytetrafluoroethylene (PTFE) plastic or other corrosion resistant materials. In some embodiments, housing 110 may be configured in accordance with NPT Pipe Plug fittings, Sanitary Quick-Connect fittings or Tri-Clamp sanitary fittings standards in order to facilitate integration with widely-used industrial equipment.

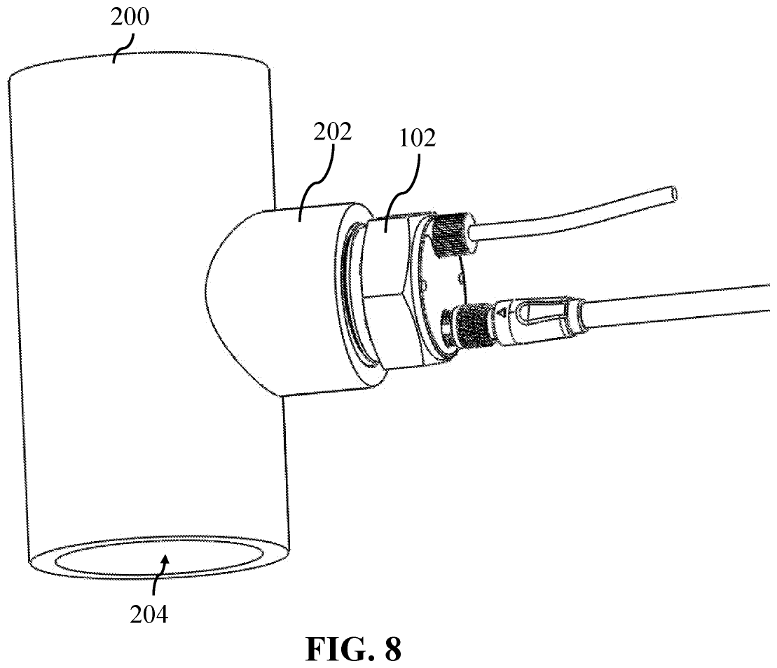

Housing 110 is configured for at least partial insertion into a coupling 202 of a structure 200 of a chemical processing facility having a cavity 204 through which an industrial process stream flows. For example, as shown in FIGS. 8-10, structure 200 may comprise a pipe, tank, duct or other component having a cavity 204 through which the industrial process stream flows or resides. Housing 110 may comprise a coupling component 112 such as, e.g., threading or another type of coupling, that is configured to mate with a corresponding coupling component 206 of the coupling 202, such that coupling components 112 and 206 together seal coupling 202 against egress of fluid from the industrial process stream with armature 150 extending into cavity 204 and sample unit 170 disposed within cavity 204 in the industrial process stream.

With reference to FIGS. 1, 4 and 5, cover plate 114 is removable to expose proximal cavity 126 and circuitry 132. In some embodiments, for example, circuitry 132 may be removed and replaced or otherwise accessed by removing or opening cover plate 114. In some embodiments, light source 134, filters 140 and reflective component 128 may also be accessed or replaced by removing cover plate 114 to access proximal cavity 126. In some embodiments, cover plate 114 may be removable in-situ for field repair or replacement of components of sensor device 102 without the need to decouple sensor device 102 from structure 200.

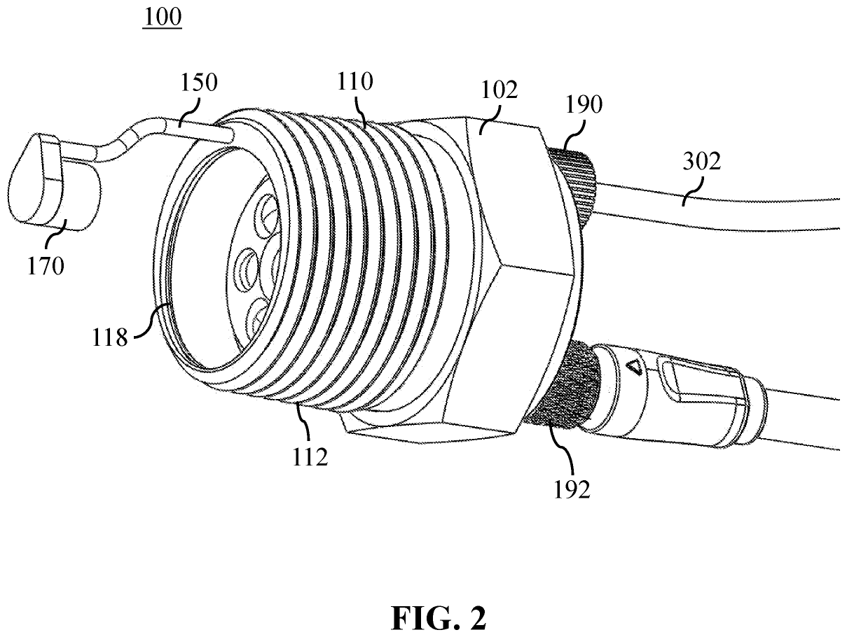

With reference to FIGS. 2, 3, and 10, distal cavity 116 faces toward cavity 204 of structure 200 and optically exposes illumination lens component 122 and receptor lens components 124, and the corresponding light source 134 and optical sensors 138, to the industrial process stream and a sample fluid found in sample unit 170. For example, window 118 is configured to seal distal cavity 116 against the fluid and pressure of the industrial process stream flowing through cavity 204 of structure 200 and inhibit the pressure and fluids of the industrial process stream from entering distal cavity 116. Window 118 also allows light signals emitted by light source 134 and traveling through illumination lens component 122 to enter the industrial process stream, e.g., toward a fluid sample found in sample unit 170, and any fluorescence or reflections from the fluid sample to exit the industrial process stream and be detected by optical sensors 138 via receptor lens components 124. In some embodiments, window 118 may comprise an optically transparent window. As an example, window 118 may be formed of a material such as quartz, glass or any other material that is transparent to the wavelength of light selected for emission by light sources 134 toward sample unit 170 or emitted/reflected from the fluid sample back toward optical sensor 138.

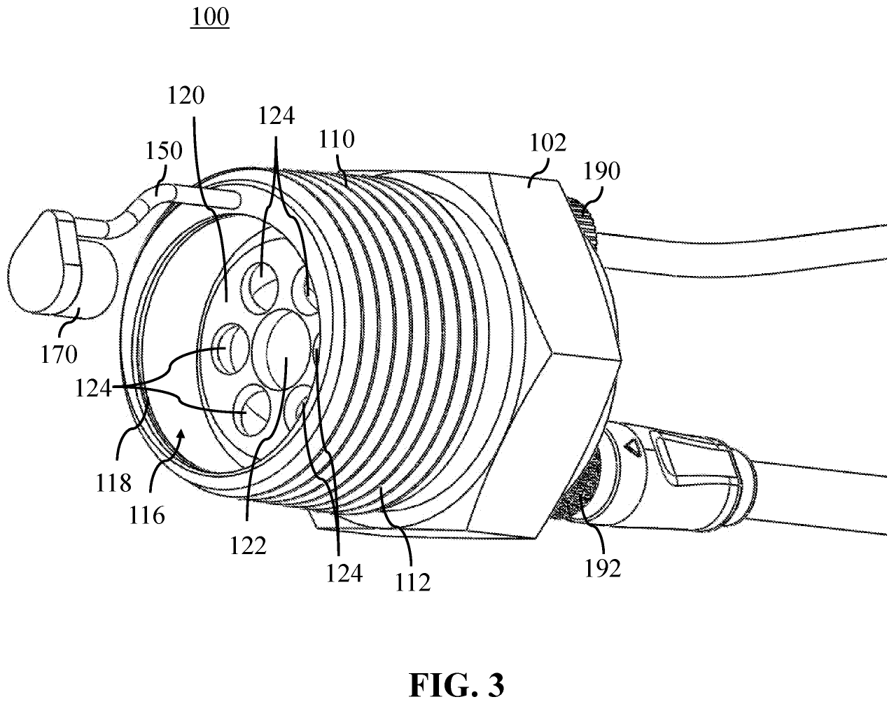

With reference to FIGS. 3, 5 and 13, separation plate 120 is disposed between distal cavity 116 and proximal cavity 126 and comprises through holes 121 containing illumination lens component 122 and receptor lens components 124. Reflective component 128, e.g., a mirror or other reflective material, is attached to separation plate 120 facing in a proximal direction. In some embodiments, separation plate 120 is integrally formed with housing 110.

Illumination lens component 122 is configured to direct light beams 142 from light source 134 toward sample unit 170. In some embodiments, illumination lens component 122 may comprise a collimating lens. In other embodiments, other types of lenses may also or alternatively be utilized.

Receptor lens components 124 are configured to direct light beams 144 from sample unit 170 toward optical sensors 138. In some embodiments, for example, one or more of receptor lens components 124 may comprise collimating lenses. In other embodiments, other types of lenses may also or alternatively be utilized.

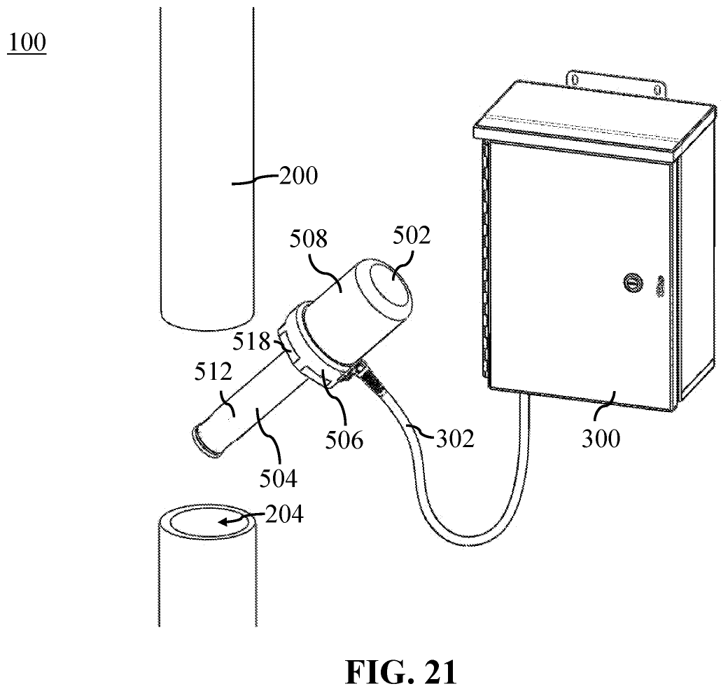

Reagent flow channel 130 is configured to provide a flow path for coupling fluid inlet connection 190 to a corresponding flow channel 152 in armature 150 to supply reagent received from a fluid supply 300 (FIG. 21) via fluid supply tubing 302 to sample unit 170. For example, fluid supply tubing 302 may connect to a tube fitting receptacle (TFR) of housing 110. The TFR receptacle is configured to receive chemical reagent, which is pumped from fluid supply 300, e.g., an auxiliary fluid metering device. The chemical reagent may comprise a fluorescent dye, fluorophore molecules, microbes, fluorescent protein, water, lens cleaner or any other reagent. Fluid entering the TFR travels through a pinhole to the high-pressure side of sensor device 102, and exits through an orifice. The orifice may contain a tube or baffle configured to secrete the fluid at the focal volumetric region of the sensor device's optics. In some embodiments, the orifice may comprise a tube or baffle configured to project pressurized fluid at window 118, e.g., to clean the surface of window 118.

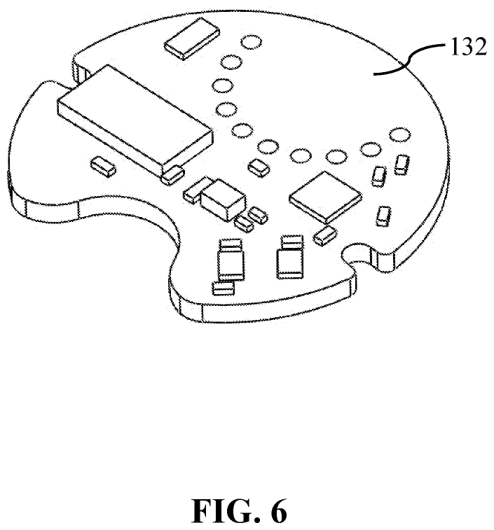

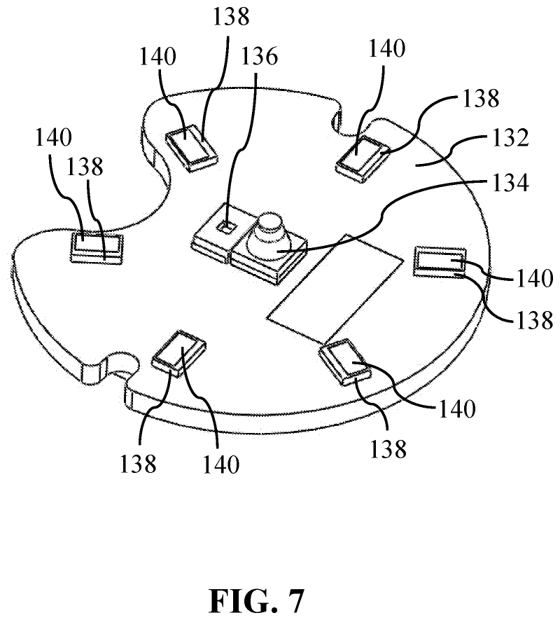

With reference to FIGS. 6 and 7, circuitry 132 comprises, for example, a processor, a microprocessor, a microcontroller (MCU), an application-specific integrated circuit (ASIC), a field-programmable gate array (FPGA), a graphics processing unit (GPU), a printed circuit board (PCB), an analog-to-digital converter (ADC), a digital-to-analog converter (DAC), sensor interfaces, motor controllers, a power supply, a communication interface or any other type of processing circuitry, as well as portions or combinations of such circuitry elements. Circuitry 132 may also comprise memory components such as, e.g., random access memory (RAM), read-only memory (ROM), flash memory or other types of memory, in any combination. The memory and other memories disclosed herein should be viewed as illustrative examples of what are more generally referred to as “processor-readable storage media” that may store executable program code of one or more software programs. One or more of light source 134, optical sensors 136 and brightness detector 138 may be physically coupled to circuitry 132 or may be attached to housing 110 in another manner.

Circuitry 132 may comprise electrical fault protection circuitry in order to ensure resilience to electrical noise commonly found in industrial facilities. In some embodiments, circuitry 132 may comprise a serial communication interface in accordance with RS-485 standards. Sensor device 102 may communicate with industrial process control equipment using a standardized protocol such as MODBUS. A data input/output connection 192 protrudes from the housing 110 on the dry-side of housing 110 and is configured for connection to a standardized industrial wiring cable in some embodiments.

In some embodiments, electrical connections may be vulnerable to corrosion from an acidic environment. Sensor device 102 may be configured for non-electrical communication with the host computer, such as RF telemetry or fiber optic communication. For example, sensor device 102 may be configured to receive power without electrical communication, e.g., through a fiber optic cable or an on-board energy harvesting system.

In some embodiments, circuitry 132 may be divided into two sections which are in electrical communication, but thermal isolated, in order to inhibit the power supply from influencing the temperature of the optical sensors 138 and instrumentation circuitry.

With reference to FIGS. 7 and 11-13, light source 134 is configured to illuminate a fluid sample contained within sampling unit 170 in order to cause the fluid sample to fluoresce or reflect light. The brightness of light source 134 may be modulated by circuitry 132, for example, by DAC circuitry which is in communication with an MCU. In some embodiments, light source 134 comprises an electronically modulated precision light source, for example, one or more light emitting diodes (LEDs). As an example, light source 134 may comprise several LEDs which are multiplexed by a switching circuit of circuitry 132 to the DAC in some embodiments. Other types of light sources 134 may also or alternatively be utilized including, for example, lasers xenon arc lamp, phosphor-based white light sources or incandescent lamps.

With reference to FIG. 7, brightness detector 136 is positioned to monitor the output from light source 134 and in some embodiments is optically isolated from reflections or emissions of the fluid sample contained within sampling unit 170. For example, reflective component 128 may be position distally of brightness detector 136 when circuitry 132 is installed in proximal cavity 126 such that light emitted by light source 134 is reflected toward brightness detector 136 while fluorescence or reflections from a fluid sample contained within sample unit 170 are not received by brightness detector 136, e.g., due to there not being a through hole or lens component disposed distally over brightness detector 136.

With reference again to FIGS. 7 and 11-13, optical sensors 138 are disposed on circuitry 132 and positioned proximal of receptor lens components 124 such that they are exposed to light received via receptor lens components 124 from a fluid sample contained in sample unit 170. Optical sensors 138 may comprise, for example, photodiodes or any other type of optical sensor. In some embodiments, optical sensors 138 may comprise six optical sensors, e.g., as shown in FIG. 3. In other embodiments, any other number of optical sensors 138 may be utilized. In some embodiments, optical sensors 138 may be arranged radially around light source 134 with corresponding receptor lens components 124 similarly arranged around illumination lens component 122. In other embodiments, optical sensors 138 may be arranged in any other manner relative to light source 134. In some embodiments, optical sensors 138 may comprise one or more non-dispersive optical sensors.

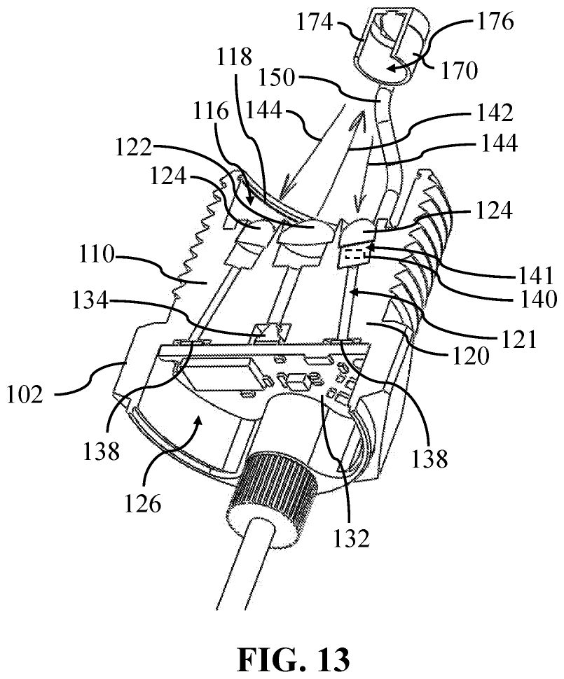

In some embodiments, as shown in FIG. 13 for example, receptor lens components 124 and the corresponding through holes 121 may be aligned along axes that are arranged radially in a cone pattern such that to the axes converge and focus on a small 3-dimensional focal volume of fluid that is in front of window 118. Receptor lens component 122 is aligned along an axis that is configured to intersect the focal volume of fluid.

In some embodiments, filters 140 may be disposed between optical sensors 138 and receptor lens components 124. As an example, filters 140 may be disposed on optical sensors 138, e.g., as a film or layer, as shown in FIG. 7. In some embodiments, filters 140 may have the same shape as optical sensors 138. In some embodiments, filters 140 may comprise band-pass filters which correspond with emission or reflectance peaks of a variety of chemical compounds. The bandpass filters may, for example, be cylindrical with the bandpass filter coating on one of the circular surfaces, an anti-reflective coating on the opposite circular surface, and a light absorbing coating, e.g., a black coating, around the cylindrical diameter.

With reference to FIG. 13, in some embodiments, separation plate 120 may comprise wells 141 in the distal ends of one or more of through holes 121 which closely match the size of filters 140, e.g., cylindrical wells that match the size of a cylindrical band-pass filter in an embodiment. Filters 140 may be interchanged within the wells 141 during assembly based on the particular use case, reagent, and wavelengths of fluorescence that will be emitted from target analytes. In some embodiments, standardized filters may be selected from a warehouse inventory and quickly assembled into the wells 141 of separation plate 120 to create made-to-order spectral sensor devices 102 that match customer specifications. In this embodiment, a short piece of fiber optic cable may be positioned distally of each filter 140 within through holes 121 with one polished end of the fiber positioned at the focal point of the corresponding receptor lens component 124. Filtered light is received by the optical fiber and transferred through a sealed pinhole in separation plate 120 to circuitry 132 and optical sensors 138.

Optical sensors 138 in conjunction with filters 140 are configured for the detection of light wavelengths corresponding to a wide range of chemical compounds that may be found in an industrial process stream.

Components of circuitry 132 (e.g., the DAC and MCU), light source 134 and brightness detector 136 may be configured as a closed-loop constant-brightness light source system that is configured to reduce or inhibit errors caused by temperature fluctuations or service life degradation of the electronic and optical components.

While components of sensor device 102 are described herein as being utilized to emit and detect visible light, in other embodiments, light source 134 and optical sensors 138 may also or alternatively be configured to emit and detect any other electromagnetic wavelength including, e.g., radio, microwave, infrared, ultraviolet light, x-rays, gamma rays or any other wavelength of electromagnetic radiation. For example, in some embodiments, the reagent may be configured to react with a target analyte to produce fluorescence or a reflection in the ultraviolet wavelength, infrared wavelength or any other target electromagnetic wavelength.

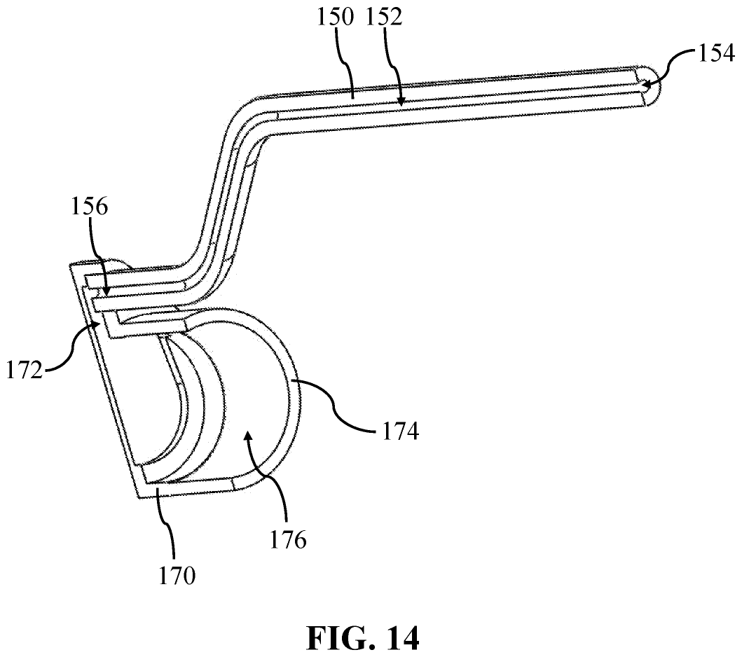

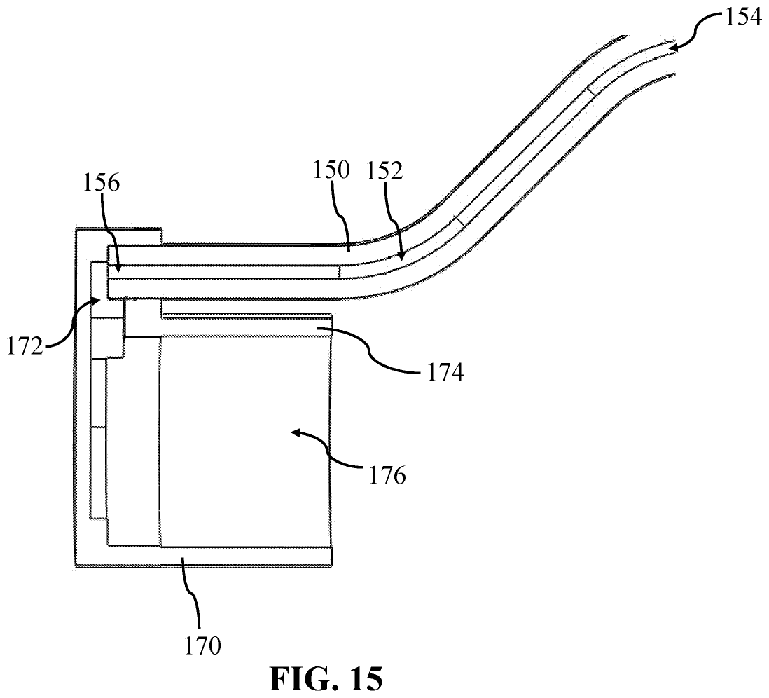

With reference to FIGS. 14 and 15, armature 150 comprises a fluid channel 152 having a proximal portion 154 that is in fluid communication with reagent flow channel 130 of housing 110 and a distal portion 156 that is in fluid communication with a reagent inlet 172 of sample unit 170.

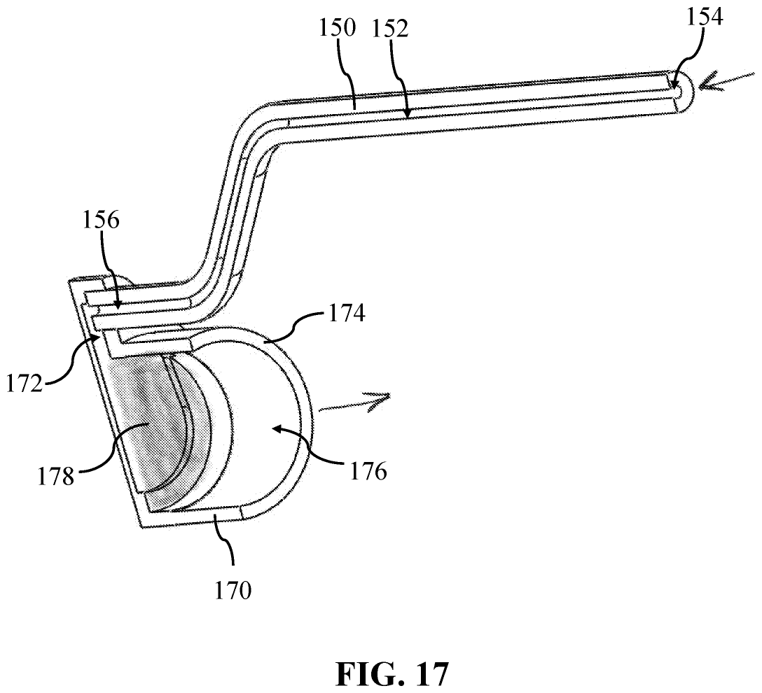

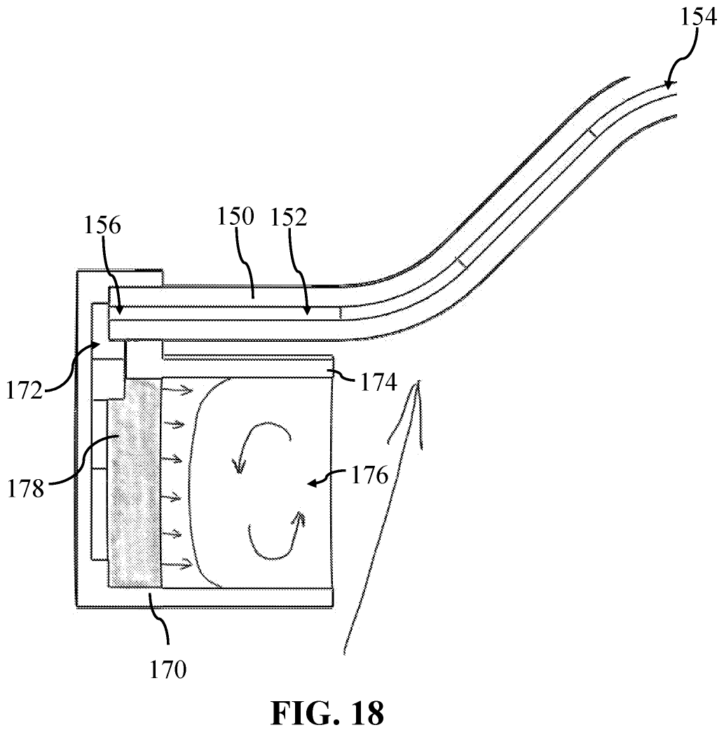

With further reference also to FIGS. 13-15, sample unit 170 comprises an annular wall 174 that forms a sample well 176 that is in fluid communication with reagent inlet 172 and, when sensor device 102 is installed on a structure 200, e.g., coupled to coupling 202, is in fluid communication with the industrial process stream. In other embodiments, wall 174 may comprise other shapes such as, e.g., a square, oval, or any other shape. With reference to FIGS. 17 and 18, sample unit 170 may comprise a membrane 178 disposed at a bottom of sample well 176 adjacent reagent inlet 172 that is configured to receive reagent from reagent inlet 172 and dispense the reagent into sample well 176. The membrane 178 may be composed of porous matrix materials such as plastic, organic polymer, elastomer, cellulose, stainless steel, graphite or ceramic. In some embodiments, the reagent may be pumped through sensor device 102 to membrane 178 via armature 150, e.g., by a pump controlled by sensor device 102 or controlled by another system according to a predetermined sample rate, as shown in FIG. 17.

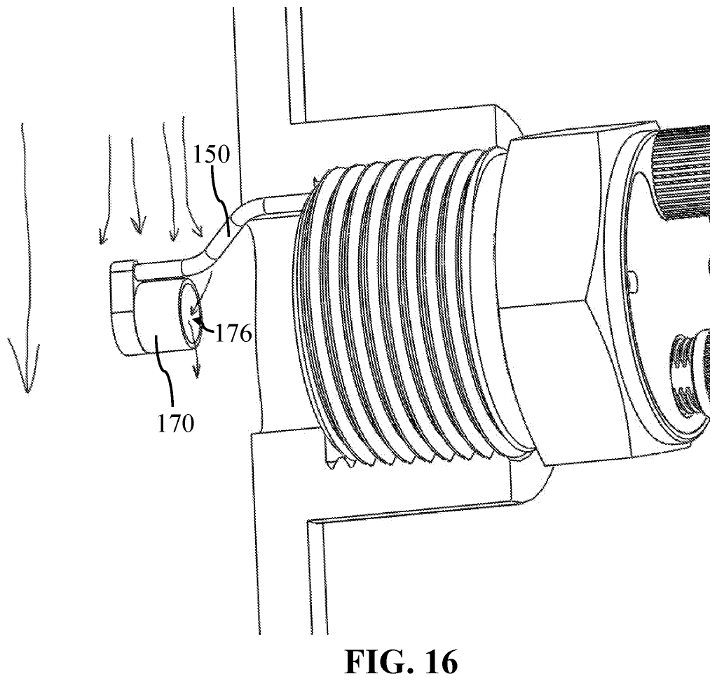

FIGS. 16-18, illustrate an example flow of the industrial process stream across sample unit 170. As seen in FIG. 16, for example, the industrial process stream may enter and fill sample well 176, e.g., becoming a fluid sample as described above. In some embodiments, sample unit 170 is configured and oriented such that the industrial process stream travels perpendicular to the opening of sample well 176 such that fluid entering sample well 176 may exhibit a period of reduced flow or dwell when captured relative to the flow of the industrial process stream. In some embodiments, further flow of the industrial process stream may cause turbulence in the fluid sample contained within sample well 176, e.g., as shown in FIG. 18. In other embodiments, the opening of sample well 176 may be disposed at any other angle depending on a desired amount of turbulence and fluid turnover in sample well 176. Turbulence in sample well 176 caused by the industrial process stream may be leveraged to effect a mixing of the reagent with the analyte within the fluid sample as the reagent is pumped through membrane 178 into sample well 176. Sensor device 102 may then perform measurements on the fluid sample in the sample well to determine a concentration of the target analyte in the industrial process stream.

As described above, sensor device 102 comprises a fluid reactor, e.g., sample well 176 of sample unit 170, that does not contain moving parts in some embodiments. Sample well 176 remains open in the turbulent crossflow and may be referred to as a “well” fluid mixer, which uses turbulence caused by cross-flow to create an eddy current within sample well 176. The turbulence and eddy current simultaneously mix and hold the fluid sample in place for imaging within sample well 176. Sample well 176 may also be positioned at the focal plane of the sensor device 102, e.g., the lens components 122 and 124 or optical sensors 138. When installed in structure 200, e.g., in a pipe tee for example, the industrial process stream flows across the sensor head for continuous measurements. The reagent is dispensed into sample well 176 through membrane 178 as described above, which functions to create back-pressure on the reagent stream and forces the reagent to be secreted evenly across the planar surface of the sample well 176. This configuration aids in maintaining a diffusion layer that is adjacent to the eddy current. The region of mixed sample and reagent are optically active or fluorescent and represent an activated sample of the process stream.

Circuitry 132 comprises firmware calibration algorithms which function to compute a concentration of a target analyte chemical compound based on brightness measurements of the filtered light signals. For example, electrical currents generated by optical sensors 138 are received by components of circuitry 132 such as, e.g., a signal multiplexer that may be controlled by the MCU. The output of the multiplexer may be connected to an operational amplifier with a precisely-tuned gain. The current received from sensor devices 138 may be circulated through a resistor that is located in close proximity to the amplifier and a voltage drop across the resistor may act as the input signal to the amplifier where the amplifier output signal squared is proportional to the power dissipated by the resistor. The amplifier output signal is in electrical communication with an ADC that communicates brightness measurement data to the MCU. The brightness measurement data is utilized as an input variable to compute the chemical concentration of the target analyte. In some embodiments, the firmware may comprise several bandpass channels in computation of the concentration of one chemical compound.

Sensor device 102 takes advantage of the physical interaction between an analyte and the reagent. An analyte is the specific materials or chemical compounds for which the chemical concentration is being measured by sensor device 102. The reagent may comprise an engineered chemical compound, genetic material or microbial matter; which is dispersed in a carrying fluid to facilitate precise dispensing and mixing. Sensor device 102 comprises an integrated fluid control system that functions to cause an interaction between a controlled volume of fluid sample, e.g., obtained from the industrial process stream in-site by sample unit 170, with a controlled volume of the reagent, e.g., provided to the fluid sample in sample well 176 by fluid inlet connection 190 via reagent flow channel 130, fluid channel 152, reagent inlet 172 and membrane 178. While a fluid sample is referred to herein as being taken from an industrial process stream, the fluid sample may alternatively be taken from any fluid system including, e.g., reservoirs, lakes, streams, water supply flows, waste treatment fluid flows, the ocean, or any other fluid system.

As described above, sensor device 102 is configured for at least partial immersion within the industrial process stream, e.g., with sample unit 170 disposed within cavity 204 of structure 200, to facilitate continuous or rate-based monitoring of fluids of the industrial process stream that are flowing through the structure 200.

Sensor device 102 is configured to measure the concentration of an analyte within the industrial process stream by detecting photon emissions generated by the interaction between the analyte and the reagent in sample well 176. For example, sensor device 102 is configured to detect and measure light emitted by the interaction between the analyte and the reagent in sample well 176. As part of this measurement, sensor device 102 is configured to execute a process that ensures the natural emission of light by this analyte-reagent interaction behaves in a predictable trend that is selectively related to the presence of the analyte in the industrial process stream. This enables sensor device 102 to measure the concentration of the analyte by measuring the intensity of light emitted by the mixture of the analyte and reagent in the fluid sample held within the sample unit 170.

In addition, sensor device 102 is configured to consider the conditions or attributes of the industrial process stream that may cause a decrease in the accuracy of measurements by sensor device 102 or completely prevent measurements by Sensor, e.g., by denaturing the reagent. As an example, acidity or other attributes of the industrial process stream may influence the ability of sensor device 102 to measure the analyte-reagent interaction. In order to mitigate the effects of such conditions or attributes, sensor device 102 is configured to prepare or modify a small volumetric fluid sample of the industrial process stream to enhance compatibility with reagent, e.g., by capturing the fluid sample within sample well 176 for mixing with reagent supplied via membrane 178.

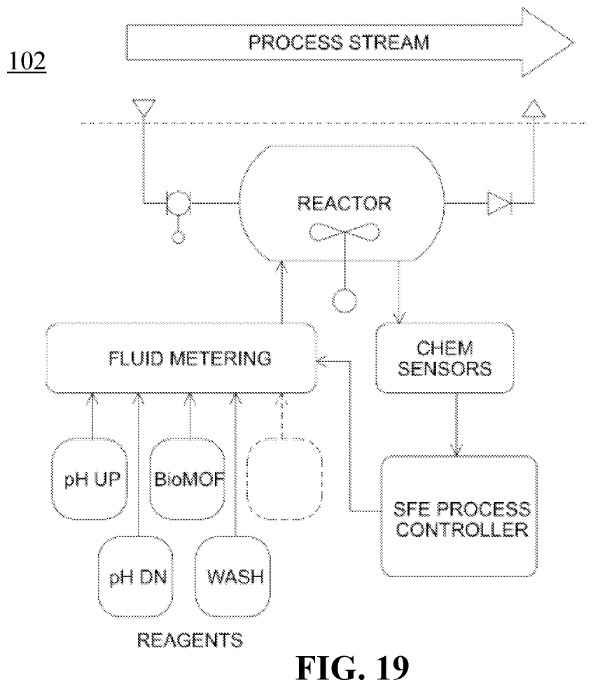

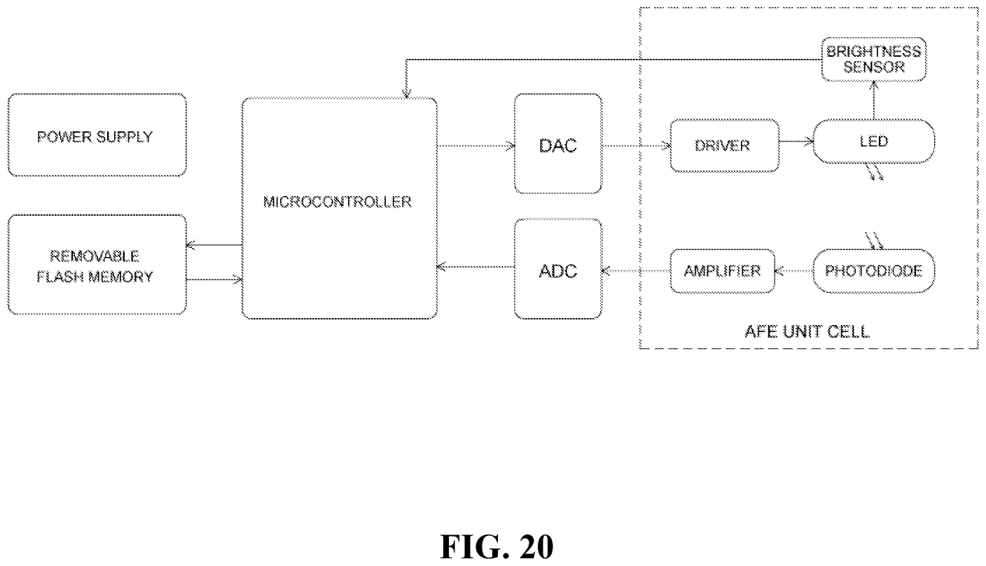

With reference to FIGS. 19 and 20, sensor device 102 comprises several subsystems that may be implemented by circuitry 132 including, for example, a fluid control system, a metering pump, an opto-fluidic reactor cell, one or more non-dispersive bandpass photometric detectors, a precision light source, an electronic preamplifier, an analog-to-digital converter, a temperature sensor, a pH sensor, a pressure sensor and any other components.

Sensor devices 102 are configured to be modular and configurable, e.g., during manufacturing or after use. As an example, the particular filters 140 to be included in sensor device 102 may be selected to correspond to optical characteristics of the chemical of interest and corresponding programming of specialized calibration firmware into sensor device 102 may be performed for those filters 140 and chemical of interest.

The interaction of a particular reagent with a corresponding target analyte produces a unique spectral distribution of light emissions. The luminous magnitudes of the unique peaks in this signature are quantified by the optical sensors 138 of sensor device 102 in order to measure the corresponding chemical concentration. Raw optical sensor data is processed by the on-board processing of circuitry 132 to compute the concentration. Particular filters 140 that have a center wavelength corresponding to a region of the spectrum where the analyte may be detected exclusively may be selected for inclusion in sensor device 102. In order to configure a sensor device 102 for a particular target analyte, the emission spectrum of the analyte as well as other emissive materials found in the industrial process stream are characterized and corresponding filters 140 are selected in regions where spectra do not overlap, resulting in a filter array which is selective for the detection of the target analytes. The ratio of the analyte's luminous intensity to the intensity of competing materials is referred to as the signal-to-noise ratio (SNR).

As mentioned above, the environment of the industrial process stream is often hazardous and contains elements or other attributes which may degrade the capability of sensor device 102. Sensor device 102 is a compact integrated device comprising numerous sub-systems, each serving a particular purpose in supporting measurements.

With reference to FIGS. 21-29, a sensor device 502 according to another embodiment will now be described. Sensor device 502 comprises a shape that may be described as a barbell or tubular shape although such a description of the shape of sensor device 502 is not intended to be limiting and any other shapes may be utilized. Sensor device 502 is configured for insertion into structure 200 in a similar manner to sensor device 102. In some embodiments, the manner of coupling sensor device 502 to structure 200 may be different than that used for sensor device 102.

Sensor device 502 comprises a distal region 504, an intermediate region 506 and a proximal region 508.

Distal region 502 is configured for suspension within the fluid process stream and may also be referred to herein as the sensor head. In some embodiments, distal region 502 may be configured to be intentionally positioned in such a way to create turbulence or back-pressure in the industrial process stream. The turbulence may serve to increase the dispersion and mixing of analytes within the fluid sample. In some embodiments, distal region 502 may comprise a cylindrical shape. Distal region 502 comprises a central chamber or cavity 510 and is formed of two co-axial cylindrical members that are configured to form a valve. For example, an outer cylindrical member 512 may be tubular with two opposing orifices 514 and 516 arranged radially or in any other configuration. The opposed orifices 514 and 516 allow fluid from the industrial process stream to flow through the chamber 510. Outer cylindrical member 512 is not configured to rotate in some embodiments and extends toward a flange 518 of intermediate region 506. Flange 518 is configured for panel-mounting to coupling 202 of the structure 200 containing the industrial process stream. Outer cylindrical member 512 and flange 518 may together function structurally to fix sensor device 502 rigidly relative to structure 200 and to allow for rotation of the inner cylindrical member 520 therein. Flange 518 may comprise seals that inhibit fluid from leaking out of structure 200 or beyond chamber 510.

Inner cylindrical member 520 comprises a radial passage 522 disposed between wall members 524. When passage 522 is aligned with the orifices 514 and 516 of outer cylindrical member 512, fluid of the industrial process stream flows freely through orifices 514 and 516 into chamber 510. When wall members 524 are aligned with orifices 514 and 516, fluid of the industrial process stream is inhibited from flowing freely through orifices 514 and 516 into chamber 510.

Inner cylindrical member 520 comprises a dynamic seal, configured to inhibit fluid from entering the hollow portion of outer cylindrical member 512. Inner cylindrical member 520 is configured to rotate co-axially within the outer cylindrical member 512 and is configured in mechanical communication with a tubular shaft 526.

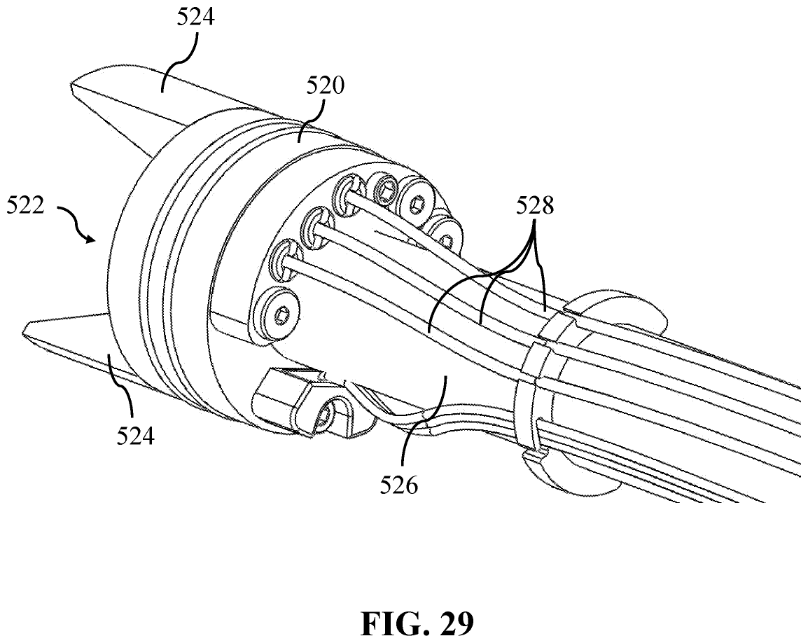

Intermediate region 506 comprises tubular coaxial members and may also be referred to as the “stem”. Several tubes of varying diameter may be arranged coaxially to allow for independent rotation of each tube relative to the other tubes. Each layer of the coaxial tubes may contain seals that inhibit mixing of contents between layers. The stem serves as a cantilever in combination with the outer cylindrical member 512, and the flange 518. The length of the stem may be configured for specific lengths allowing for accurate positioning of distal region 504 within the process stream. The stem may comprise wires or cables 528 (FIG. 29) allowing for electrical or optical communication of elements in the distal region 504 with elements outside of distal region 504.

Proximal region 508 is located outside of structure 200. Proximal region 508 may also be referred to herein as the “body”. The body is in mechanical communication and fixed to the flange 518. The body comprises an attached actuator which may be powered by electricity or compressed air. Motion generated by the actuator may be coupled to shaft 526 within the stem, allowing motion to be transferred to the inner cylindrical member 520 of the distal region 504.

Powered rotation of elements within the sensor device 502 results in intermittent blockage of the radial orifices 514 and 516 from chamber 510, e.g., due to wall members 524. Blocking of the orifices 514 and 516 may be modulated using the actuator. The mechanical arrangement of the components described herein provide a method of sampling a fixed volume of fluid from the industrial process stream, e.g., the fluid sample captured in chamber 510 when orifices 514 and 516 are blocked by wall members 524. When orifices 514 and 516 are opened, the captured fluid is washed away by the industrial process stream and replaced by a fresh sample.

In some cases, even a sealed sample of the industrial process stream may be unfit for predictable interaction with a reagent. Sensor device 502 comprises a system that is configured to modify the sample fluid to allow for precise measurement reaction. For example, in some embodiments sensor device 502 may be configured to modify the fluid sample by mixing the fluid sample with a buffer solution. For example, the buffer solution may comprise chemicals or materials that are configured to induce a reaction with the sample fluid, resulting in a specific acidity level. For example, sensor device 502 may comprise a system that is configured to control the pH before measurement.

Dispensing of buffer solution and reagent into chamber 510 results in volumetric displacement. Distal region 504 may comprise a check-valve that is configured to allow for displacement of fluid from inside chamber 510 while preventing back-flow and contamination of the sealed fluid sample.

The addition of solutions to the sealed chamber may also result in a change in the concentration of the fluid sample. In order to control for such dilution, the buffer and reagent may comprise specific characteristics that enable sensor device 502 to accurately compensate for the change in concentration when taking a measurement. For example, an amount of buffer and reagent to be utilized may be known in advance and a corresponding change in concentration of the fluid sample may be adjusted accordingly.

In some embodiments, liquid solutions may be stored in sealed vessels located within sensor device 502, e.g., within distal region 504, intermediate portion 506 or proximal portion 508. The liquid solutions may be consumable and may need periodic replacement, either manually by an individual or through the use of piping and pumps to a liquid solution source such as, e.g., a laboratory that prepares fresh liquid solution. The fresh solution may then be prepared then pumped toward sensor device 502 for continuous operation. In some embodiments, high precision pumps may be utilized for pumping buffer and reagent solutions to ensure accuracy of the measurements. Sensor device 502 may also be configured to inhibit the fluid of the industrial process stream from diffusing into other portions of sensor device 502. For example, sensor device 502 may comprise check valves located at the inner cylindrical member 520 or intermediate region 506 that provide a hermetic seal to inhibit the corruption of the solutions or other components of sensor device 502. Where gas or chemical products produced by the buffering process may have an effect on the measurement data, the buffer to be utilized by sensor device 502 may be selected such that such effects are minimized. A filter membrane may also be included that is configured to trap or concentrate particles within the solution on a specific plane.

In some embodiments, during periods of inactivity, sensor device 502 may be configured to execute a hibernation mode in which the distal region 504 closes passage 522 and fills chamber 510 with a non-corrosive fluid. In some embodiments, the fluid control system may be accessed by an integrated control system for the purpose of dispensing acid, caustic or detergent solutions in order to clean the lenses and fluid control elements.

Sensor device 502 is configured for precise measurement of light transmitted within the fluid sample. In some cases, light produced by the fluid sample may have a small luminous intensity. Sensor device 502 may be designed for maximum optical gain to provide the highest possible signal-to-noise ratio. For example, chamber 510 may comprise materials that are configured to block nearly all ambient light during measurement when passage 522 is closed. As an example, the inner surfaces of chamber 510 may be mirrored to prevent absorption of light energy by the chamber walls, and thereby maximize the signal strength. The mirrored inner surfaces may form an optical resonator.

The photodetector of sensor device 502 may operate in at least two modes of operation. For example, one mode operation may be utilized for detection of emissions generated by the processed and activated sample solution. Another mode of operation may be utilized to measure reference light pulses produced by light sources of the sensor device.

Chamber 510 may comprise a lens that is configured to concentrate emissions received by a large area of sample solution onto the active element of the photodetector. Multiple photodetectors may be arranged in an array behind the lens. The photodetectors may contain optical filter materials which limit the sensitivity of discrete photodetectors to a specific wavelength. Light sources may contain lenses or mirrors which function to disperse light evenly through chamber 510. Alternatively lenses or mirrors may function to transmit light beams along a specific path.

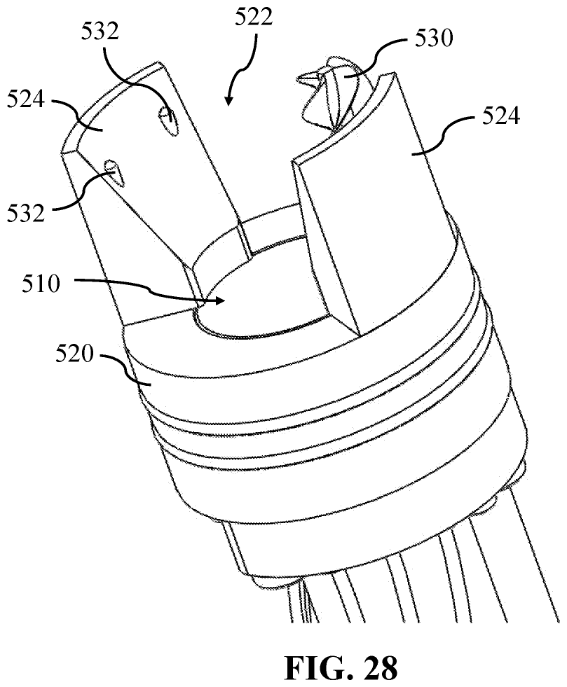

With reference to FIG. 28, sensor device 502 may comprise a pH sensor that is configured for continuous measurement of acidity level within chamber 510. The inner cylindrical member 520 may comprise conductive probes coated with corrosion-inhibiting material such as carbon nanotube ink that are in electrical communication with circuitry in the sensor body. Measurement of voltage on the probes 532 is used to compute pH of the solution where electrical excitation of the solution may be achieved through the electrodes.

Sensor devices 102 and 502 are configured to provide a furnished measurement of concentration to a computing device. The measurement may be in calibrated SI units such as, e.g., milligram per Liter or non-SI units such as parts-per-million. The sensor devices 102 and 502 perform all activity required for precise measurement and computation of concentration autonomously and continuously as controlled by a host computer. The automated process by which the sensor devices 102 and 502 perform a single measurement may be referred to herein as a cycle.

The measurement of a sample by sensor device 502 may comprise opening orifices 514 and 516 in the distal region 504 for a specific time period to allow for fresh fluid from the industrial process stream to flow into, wash and purge the sensor head. Next the orifices in the sensor head are closed such that a known volume of sample solution is isolated inside chamber 510. pH instrumentation is activated to measure the acidity of the sample and a titration calculation is computed to determine the theoretical quantity of buffer solution required in order to arrive at the specific nominal pH for measurement. Buffer solution is dispensed into the chamber and the chamber is mixed for a specific time period to allow for chemical buffering to occur. A pH measurement is acquired and if the pH of the buffered sample is not acceptable, the buffering process repeats until pH is within tolerance of the target value. A specific quantity of reagent is dispensed into the chamber through an orifice 534 and the mixer 530 is activated for a specific time period. The optical instrumentation is then activated to acquire an optical transmissivity measurement. The luminous intensity of the reagent emissions is quantified, and all input data is processed through a computation algorithm to yield a corrected value for concentration of the analyte in the sample fluid.

Similar steps may be performed for measurement of a sample by sensor device 102 except in the case of sensor device 102, measurement is taken from the open sample well 176 which is configured to temporarily hold the sample still enough to take the measurement and also relies on mixing performed by turbulence as opposed to mechanical actions within the device.

The MCU of Circuitry 312 comprises computational firmware which acts to receive raw optical and auxiliary sensor data that results from the measurement process and to translate the raw data into chemical concentration units such as, e.g., parts-per-million. The algorithm is in the form of a finite state machine (FSM), performing a large number of math operations, such as multiplication and addition, at high speed in order to translate the raw data into an accurate concentration measurement. The algorithm utilizes a look-up-table (LUT) calibration curve array. The calibration curves may be stored by users in flash memory or any other computer readable medium and may be in the form of comma-separated-variable (CSV) files. Any other format may alternatively be utilized. Each LUT correction operation is performed in sequence by the FSM computer. A CSV calibration file comprises data points corresponding to an X axis and a Y axis. The MCU may utilize linear interpolation between each X, Y point in order to compute a calibrated output value for the input value.

For example, the electronic instruments which interface with optical sensors 138 such as, e.g., photodiodes, may produce 10-bit raw ADC values ranging from 0 to 1023, corresponding to the photodiode current. This raw value may contain sources of error as the signal relates to optical signal strength or chemical concentration. One example source of error may be temperature fluctuations acting on the photodiode. A calibration curve relating the relative photodiode efficiency to its temperature may be stored in memory. The algorithm acts to compensate for the effect of temperature by looking up the appropriate correction factor based on temperature measurements.

Laboratory analytical equipment such as spectrometers or fluorometers may be used to generate complex calibration curves relating luminous intensity to concentration. Reference samples containing known quantities of analyte may be prepared in the lab and characterized using a spectrometer. Furthermore, an array of experiments can be conducted to characterize spectral intensity vs. concentration at varying temperatures, pH levels, pressures or any other attributes of the industrial process stream or sensor environment. A complex system of calibration curves may be stored in flash memory of sensor device 102 and may be accessed by the FSM algorithm based on auxiliary sensor data. In some embodiments, the algorithm may activate or deactivate calibration curves based on thresholds defined by the auxiliary sensor data.

A linear computation method supports complex mathematical functions that may be executed using a processor that is small, reliable, temperature-stable, inexpensive and consumes little power. In contrast to a high-performing microprocessor utilizing sophisticated mathematical functions and a high-level operating system, the FSM framework off-boards function generation to the analytical lab and delivers accurate measurements using little processing power and memory. The FSM chipset is considered to be viable in extreme temperatures, shock and vibration environments.

The CSV LUT calibration framework provides ease of use in creating and improving sensors based on spectroscopy data or computer simulations. The firmware architecture supports continuous improvement. Calibration files may be updated remotely or directly while the sensor is installed and operational, e.g., in a wired or wireless manner, through direct attachment of a flash memory stick, serial data communication, wireless data communication or in any other manner. The sensor's accuracy can be improved by firmware updates or manipulation of calibration files.

The computation algorithm comprises a mathematical function that represents the physical characteristics of factors affecting the computation of concentration from luminous intensity of the reagent interaction. Input variables to the algorithm may include, for example, the total amount of each specific solution dispensed, the temperature of solution, pressure in the chamber or well, the exact pH of the processed solution, the relative optical clarity of the processed solution or any other input variable that may affect measurement of the concentration.

In some embodiments, the mathematical function for translating these metrics into a determination of concentration may be designed based on the particular reagent and analyte. For example, the same sensor device may be configured differently for various reagents via software parameters. Parameters may be stored in a CSV file and adjusted by users. Verification of the precision of the sensor devices may be performed by measuring the concentration of known reference solutions.

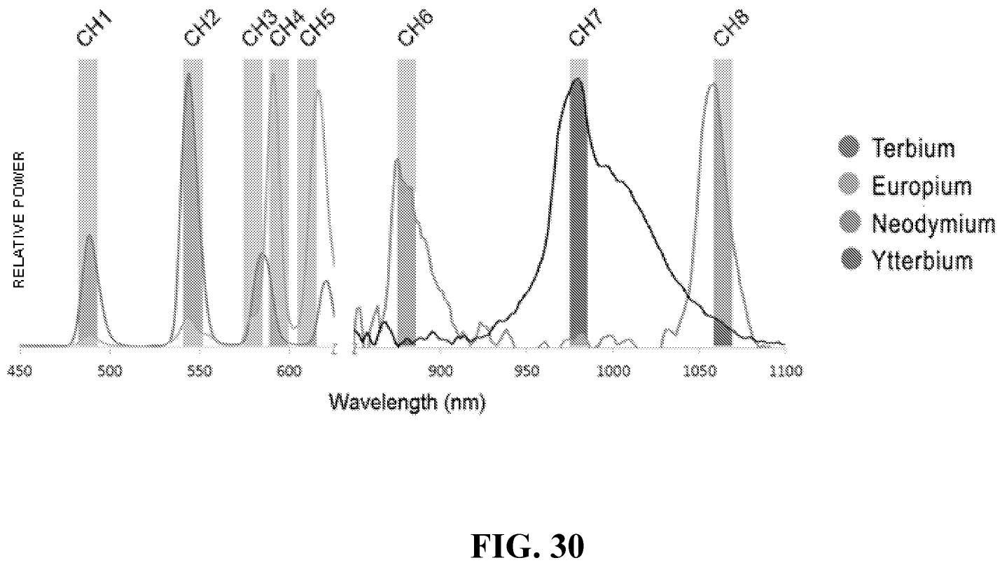

With reference now to FIGS. 30, concentration measurements are achieved by spectral analysis of fluorescent light emissions from a mixed sample of reagent, analyte and possibly a buffer solution. The 2D spectrum of each element contains unique peaks that can be discerned from the mixed signal where the locations of these peaks on the X axis are substantially fixed for a given analyte. For example, as seen in FIG. 30, each of Terbium, Europium, Neodymium and Ytterbium have unique peaks that may be detected using one or more of the reagents CH1, CH2 . . . CH8.

Sensor device 102 may be configured as an application-specific fluorometer comprising an array of non-dispersive elements which target key spectral regions as described above. For example, the sensor architecture of sensor devices 102 and 502 described herein support breakthrough size, weight and cost savings over dispersive spectrometer technologies. In addition, the architecture does not constrain the size of the optical detectors 138, resulting in improved sensitivity.

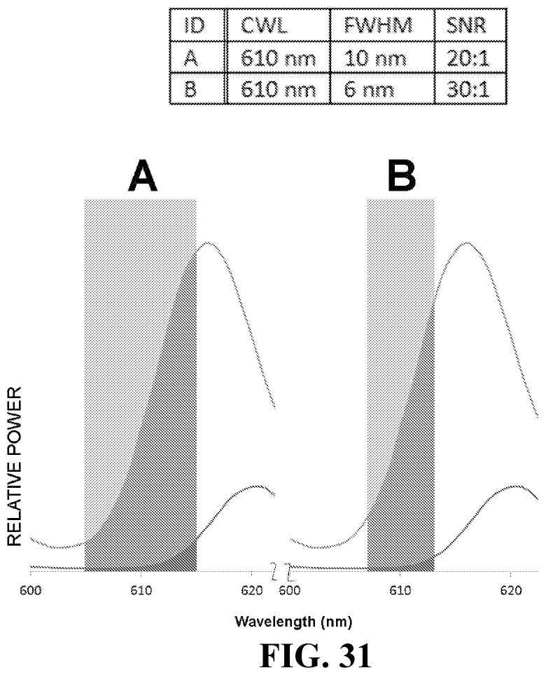

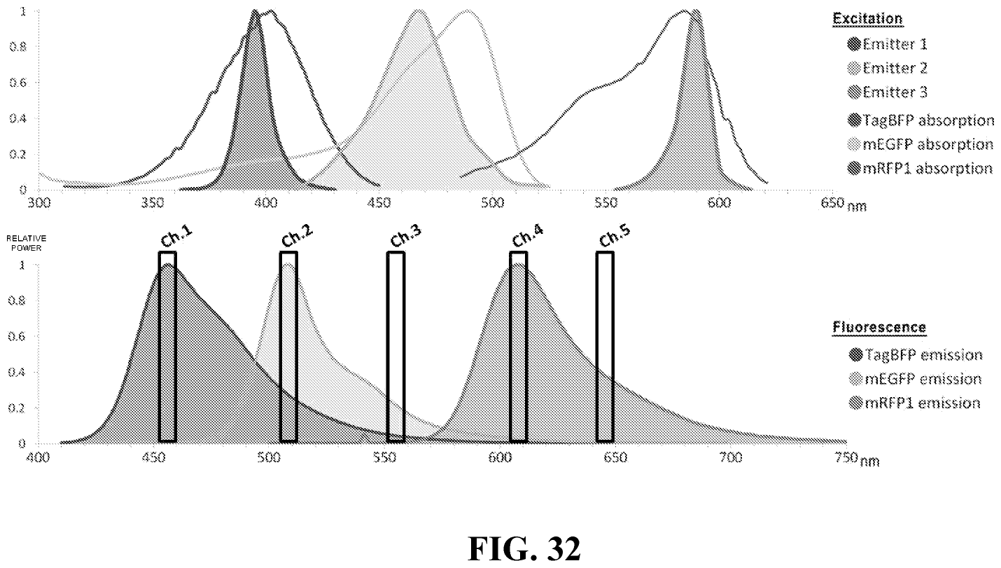

With reference to FIGS. 31 and 32, quantitative fluorescence measurements may utilize a precision light source such as light source 134. The center wavelength (CWL) and full-width-half-max (FWHM) parameters of the filters 140 may be selected in order to maximize the signal-to-noise ratio of the concentration optical sensors 138. Emitters 1, 2 and 3 of light source 134, e.g., LEDs, may be selected to target absorption peaks of the analyte or reagent, leading to excitation. Optical sensors 138 are tuned to quantify exclusively the emission peaks of the analyte.

With reference again to FIG. 30, while some emission peaks may be isolated and easy to target, in many cases there is some overlap with other emission peaks. Filters 140 may be utilized to precisely target boundaries of these overlapped curves in such a way that results in a differential signal which is representative of the element in firmware. As shown in FIG. 30, for example, Europium has an emission spectra with two significant peaks, both of which overlap with Terbium. The firmware acts to quantify Terbium first, then compute Europium based on the mixed signal. The degree to which the optics can target luminescence by Europium exclusively, will greatly contribute to accuracy. Detector channels of sensor device 102 are tuned for maximum SNR by installing specialized optical filters.

The Analog Front-End (AFE) of sensor device 102 comprises the system of photoelectric elements and associated circuitry that interface with the optics. Silicon photodiodes convert light energy to a small current which is then amplified to a range that is suitable for digitization. AFE signals are then routed to a microcontroller of circuitry 132 that provides sophisticated computational functionality. The AFE system is tuned for a dynamic range that matches the luminescence produced by the target mixed sample.

Firmware embedded in circuitry 132 computes the elemental concentration from unprocessed optical data obtained from optical sensors 138. Mathematical functions relate luminescent intensity to concentration. The embedded firmware receives luminescence data from the optoelectronic instruments such as optical sensors 138. The firmware digitally resolves the amplitude of various spectral bands and systematically deduces the concentration of each individual element from the mixed signal. The firmware also acts to translate luminosity measurements to a chemical concentration. The firmware is configured to analyze mixed signals in which the emission spectra overlap in certain regions by systematically computing the magnitude of interference where the spectra overlap in order to resolve individual elements.

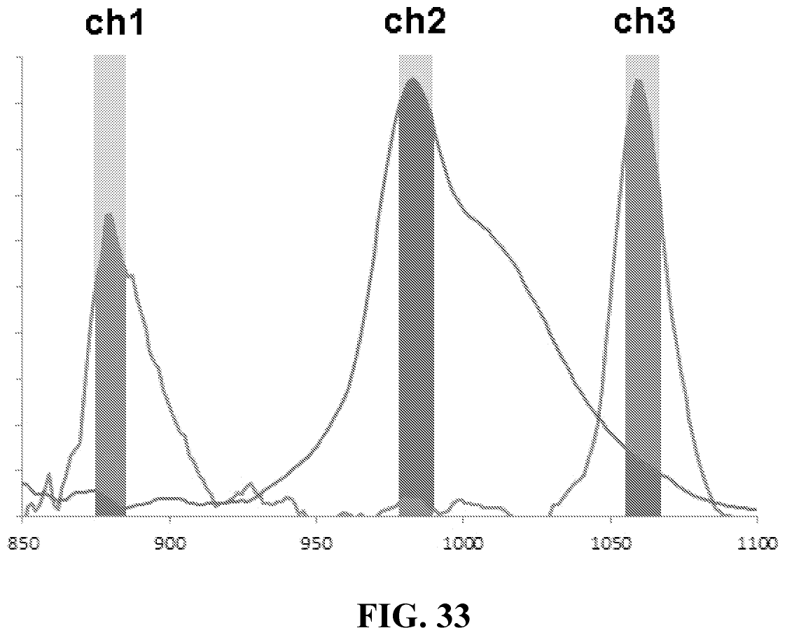

With reference to FIG. 33, an example process that may be utilized to resolve individual elements may comprise measuring the total luminescence at CH2, predicting the darker shaded region under the peak at CH3 based on CH2, measuring CH3 and subtracting the darker shaded region to obtain the lighter shaded region under the peak, then predicting CH1, measuring CH1, computing the error, and repeating the process as needed to achieve convergence.

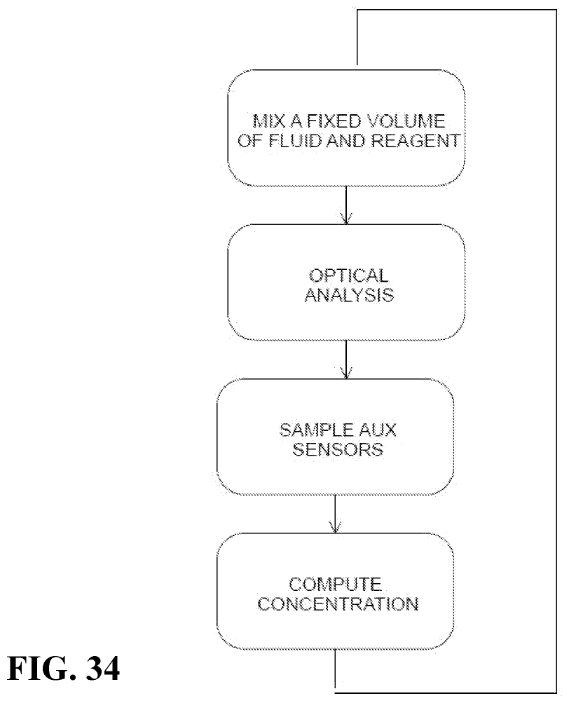

With reference to FIG. 34, an example process for computing a concentration of an analyte may comprise mixing a fixed volume of fluid and reagent, performing an optical analysis of the mixed solution, sampling auxiliary sensors such as pH, temperature, pressure, and computing the concentration based on the optical analysis and any corrections needed based on the sampling of the auxiliary sensors.

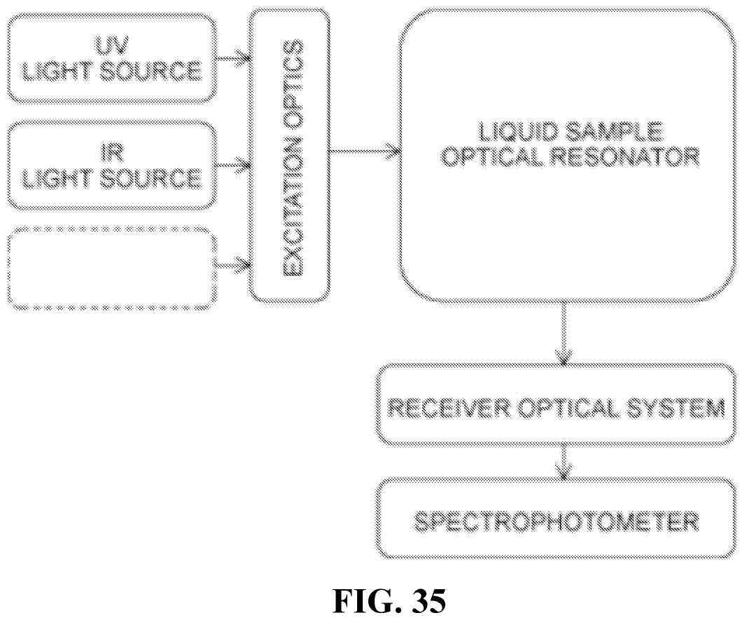

With reference to FIG. 35, an example process comprises light sources 134 emitting light, e.g., UV light, IR light, or any other electromagnetic wavelength, passing the light through lenses such as, e.g., lens 122, to excite the liquid sample contained in an optical resonator such as, e.g., sample well 176 and chamber 510, receiving light signals at lenses 124, and directing the received light to a spectrophotometer such as, e.g., optical sensors 138.

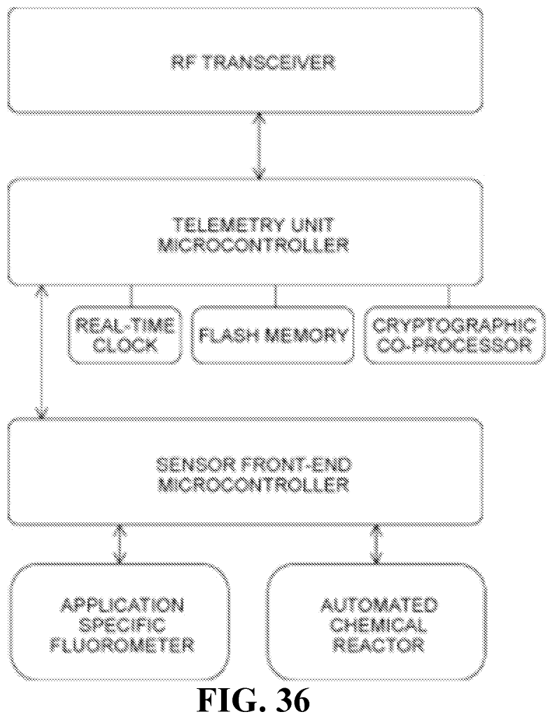

With reference to FIG. 36, example components of system 100 may comprise an RF transceiver that is in communication with a telemetry unit microcontroller. The telemetry microcontroller is configured to utilize a real-time clock, flash memory and a cryptographic co-processor and is in communication with a sensor front-end microcontroller such as, e.g., a microcontroller of circuitry 132. The sensor front-end microcontroller is in communication with an application specific fluorometer such as, e.g., optical sensors 138, and an automated chemical reactor such as, e.g., sample unit 170 of sensor device 102 or distal region 504 of sensor device 502.

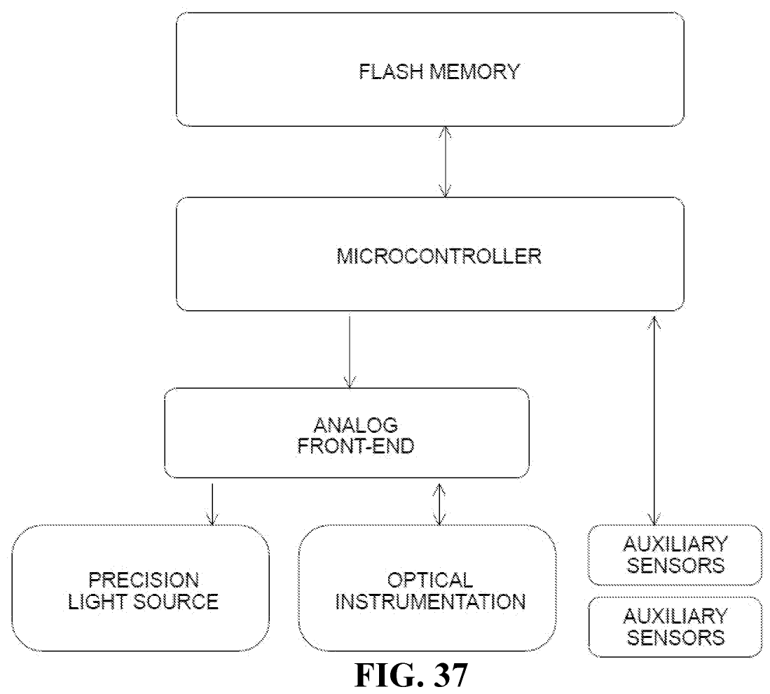

With reference to FIG. 37, example components of system 100 may comprise a microcontroller that is in communication with flash memory, an analog front-end, and auxiliary sensors such as, e.g., pH, temperature, pressure or other auxiliary sensors. The analog front-end is in communication with a precision light source such as, e.g., light source 134 and optical instrumentation such as, e.g., optical sensors 138.

FIGS. 1 through 37 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A fluid concentration measurement system comprising:
a sensor device comprising:
a sample cavity that is configured for insertion into an industrial process stream, the sample cavity being configured to obtain a fluid sample from the industrial process stream and to mix a reagent with the fluid sample in the sample cavity to form a mixed sample;
a light source that is configured to illuminate the mixed sample in the sample cavity;
an optical sensor that is configured to receive light from the mixed sample and generate sensor data based on the received light; and
at least one processor that is configured to:
obtain the sensor data;
correct the sensor data for at least one attribute of the industrial process stream; and
determine a concentration of a target analyte based on the corrected sensor data.

2. The system of claim 1, wherein the sample cavity comprises a chamber, the chamber being exposed to the industrial process stream when the sensor device is in a first configuration and being closed off from the industrial process stream when the sensor device is in a second configuration.

3. The system of claim 2, the chamber is exposed to the industrial process stream through at least one orifice when the sensor device is in a first configuration, the at least one orifice being closed when the sensor device is in a second configuration.

4. The system of claim 1 wherein the sample cavity comprises a well that is configured for positioning within the industrial process stream.

5. The system of claim 1 wherein the sensor device is configured to be removably coupled to a structure comprising the industrial process stream.

6. The system of claim 1 wherein the at least one processor is configured to obtain the sensor data, correct the sensor data for the at least one attribute of the industrial process stream and determine the concentration of the target analyte based on the corrected sensor data while the sample cavity is inserted into the industrial process stream.

7. The system of claim 1 wherein the at least one processor being configured to correct the sensor data for the at least one attribute of the industrial process stream comprises the at least one processor being configured to:
access a look-up-table corresponding to the at least one attribute of the industrial process stream; and
correcting the sensor data based at least in part on the look-up-table, a value corresponding to the at least one attribute and the sensor data.

8. The system of claim 7 wherein the at least one processor is configured to:
obtain an updated look-up-table corresponding to the at least one attribute; and
replace the look-up-table with the updated look-up-table.

9. The system of claim 1 wherein the sensor device comprises a reagent supply channel that is configured to supply the reagent to the sample cavity.

10. The system of claim 1 wherein the sample cavity comprises a membrane that is configured to dispense the reagent.

11. The system of claim 1 wherein the sensor device comprises a window, the window being disposed between the industrial process stream and the light source and optical sensor and configured to seal the light source and optical sensor from at least one attribute of the industrial process stream while permitting a transmission of light between the light source and industrial process stream and between the industrial process stream and the optical sensor.

12. The system of claim 1 wherein the sensor device comprises a filter, the filter being selected based at least in part on the target analyte and being disposed between the sample cavity and the optical sensor to filter light received by the optical sensor from the sample cavity.

13. The system of claim 12 wherein the optical sensor comprises a plurality of optical sensors, each optical sensor comprising a corresponding filter.

14. The system of claim 1 wherein the sensor device comprises a lens disposed between the optical sensor and the sample cavity, the lens being configured to collimate the light received by the optical sensor from the mixed sample.

15. A method performed by at least one processor of a sensor device, the method comprising:
causing a supply of a reagent to a sample cavity of the sensor device, the sample cavity being positioned within an industrial process stream and comprising a fluid sample of the industrial process stream, the reagent combining with the fluid sample to form a mixed sample;
causing a light source of the sensor device to illuminate the mixed sample of the sample cavity;
obtaining, from an optical sensor of the sensor device, sensor data obtained by the optical sensor based at least in part on light received from the mixed sample in conjunction with the illumination of the mixed sample by the light source;
correcting the sensor data for at least one attribute of the industrial process stream; and
determining a concentration of a target analyte based on the corrected sensor data.

16. The method of claim 15, wherein the method comprises obtaining the sensor data, correcting the sensor data for the at least one attribute of the industrial process stream and determining the concentration of the target analyte based on the corrected sensor data while the sample cavity is positioned within the industrial process stream.

17. The method of claim 15 wherein the method comprises:
accessing a look-up-table corresponding to the at least one attribute of the industrial process stream; and
correcting the sensor data based at least in part on the look-up-table, a value corresponding to the at least one attribute and the sensor data.

18. The method of claim 17 wherein the method further comprises:
obtaining an updated look-up-table corresponding to the at least one attribute; and
replacing the look-up-table with the updated look-up-table.

19. A method of fabricating a sensor device comprising:
forming a sensor device comprising a housing and a sample cavity disposed distally of the housing, the housing comprising a light source and an optical sensor, the optical sensor being optically exposed to the sample cavity;
determining a target analyte of an industrial process stream;
selecting a filter based at least in part on the determined target analyte of the industrial process stream; and
attaching the filter to the housing between the optical sensor and the sample cavity.

20. The method of claim 19 wherein:
the housing comprises a through hole having a well, the through hole optically exposing the optical sensor to the sample cavity; and
attaching the filter to the housing between the optical sensor and the sample cavity comprises positioning the filter within the well.
